(19) United States
(12) Patent Application Publication
(10) Pub. No.: US 2020/0295375 A1
(43) Pub. Date: Sep. 17, 2020

(54) ELECTRODE, SECONDARY BATTERY, BATTERY PACK, AND VEHICLE

(71) Applicant: Kabushiki Kaisha Toshiba, Minato-ku (JP)

(72) Inventors: Kazuomi YOSHIMA, Yokohama (JP); Yasuhiro HARADA, Isehara (JP); Norio TAKAMI, Yokohama (JP)

(73) Assignee: Kabushiki Kaisha Toshiba, Minato-ku (JP)

(21) Appl. No.: 16/560,071

(22) Filed: Sep. 4, 2019

(30) Foreign Application Priority Data
Mar. 13, 2019 (JP) 2019-045424

(51) Int. Cl. H01M 4/62; H01M 4/131; H01M 2/10; H01M 10/42; H01M 10/0525; B60L 7/10; B60L 50/64

(52) U.S. Cl. CPC H01M 4/625; H01M 4/131; H01M 2/1077; H01M 4/505; H01M 10/0525; B60L 7/10; B60L 50/64; H01M 10/4257

(57) ABSTRACT

According to one embodiment, an electrode is provided. The electrode includes a current collector, an intermediate layer containing a material having electrical conductivity, and an active material-containing layer containing active material particles, in this order. The intermediate layer includes at least one opening and satisfies the following formula (1).

1≤S/r≤1700 (1)

In formula (1) above, S is the ratio S_{B}/S_{A} of the total area S_{B} of the at least one opening with respect to a unit area S_{A} in the intermediate layer, and r is an average primary particle size of the active material particles.

### CROSS-REFERENCE TO RELATED APPLICATIONS

This application is based upon and claims the benefit of priority from Japanese Patent Application No. 2019-045424, filed Mar. 13, 2019, the entire contents of which are incorporated herein by reference.

### FIELD

Embodiments described herein relate generally to an electrode, a secondary battery, a battery pack, and a vehicle.

### BACKGROUND

In recent years, research and development on secondary battery such as a lithium ion secondary battery and nonaqueous electrolyte secondary batteries as high energy density batteries have been gathered pace. The secondary battery have been expected as power sources for in-vehicle power supply for hybrid automobiles and electric automobiles or uninterruptive power supply for mobile telephone base stations. Among such secondary batteries, many studies have been focusing on all-solid lithium ion secondary battery for in-vehicle battery.

The electrodes used in a lithium-ion secondary battery ordinarily have a structure in which an active material-containing layer is formed on a current collector. In the case where the active material-containing layer expands or contracts due to repeated charging and discharging, the adhesiveness between the current collector and the active material-containing layer worsens, and the electrical resistance increases. Accordingly, there is known a structure that makes peeling of the current collector and the active material-containing layer less likely by interposing an undercoat layer containing a conductive material such as carbonaceous material between the current collector and the active material-containing layer.

However, for electrodes provided with an undercoat layer, there is room for improvement in further raising the peel strength of the active material-containing layer.

### BRIEF DESCRIPTION OF THE DRAWINGS

FIG. 1 is a cross-section view, cut in one direction, of one example of an electrode according to an embodiment;

FIG. 2 is a cross-section view, cut in another direction, of one example of an electrode according to an embodiment;

FIG. 3 is a cross-section view illustrating another example of an electrode according to an embodiment;

FIG. 4 is a cross-section view schematically illustrating one example of a secondary battery according to an embodiment;

FIG. 5 is an enlarged cross-section view of a portion A of the secondary battery illustrated in FIG. 4;

FIG. 6 is a partially cut-away perspective view schematically illustrating another example of the secondary battery according to an embodiment;

FIG. 7 is an enlarged cross-section view of a portion B of the secondary battery illustrated in FIG. 6;

FIG. 8 is a perspective view schematically illustrating one example of a battery module according to an embodiment;

FIG. 9 is an exploded perspective view schematically illustrating one example of a battery pack according to an embodiment;

FIG. 10 is a block diagram illustrating one example of an electric circuit of the battery pack illustrated in FIG. 9;

FIG. 11 is a partially transparent diagram schematically illustrating one example of a vehicle according to an embodiment; and

FIG. 12 is a diagram schematically illustrating one example of a control system related to an electrical system in the vehicle according to an embodiment.

### DETAILED DESCRIPTION

According to the first embodiment, an electrode is provided. The electrode includes a current collector, an intermediate layer containing a material having electrical conductivity, and an active material-containing layer containing active material particles, in this order. The intermediate layer includes at least one opening and satisfies the following formula (1).

1≤S/r≤1700 (1)

In formula (1) above, S is the ratio S_{B}/S_{A} of the total area S_{B} of the at least one opening with respect to a unit area S_{A} in the intermediate layer, and r is an average primary particle size of the active material particles.

According to another embodiment, a secondary battery is provided. The secondary battery includes the electrode according to the embodiment.

According to another embodiment, a battery pack is provided. The battery pack includes the secondary battery according to the embodiment.

According to another embodiment, a vehicle is provided. The vehicle includes the battery pack according to the embodiment.

Hereinafter, embodiments will be described with reference to the drawings. The same reference signs are applied to common components throughout the embodiments and overlapped explanations are thereby omitted. Each drawing is a schematic view for encouraging explanations of the embodiment and understanding thereof, and thus there are some details in which a shape, a size and a ratio are different from those in a device actually used, but they can be appropriately design-changed considering the following explanations and known technology.

### First Embodiment

According to the first embodiment, an electrode is provided. The electrode includes a current collector, an intermediate layer containing a material having electrical conductivity, and an active material-containing layer containing active material particles, in this order. The intermediate layer includes at least one opening and satisfies the following formula (1).

1≤S/r≤1700 (1)

In formula (1) above, S is the ratio S_{B}/S_{A} of the total area S_{B} of the at least one opening with respect to a unit area S_{A} in the intermediate layer, and r is an average primary particle size of the active material particles.

Typically, if the active material-containing layer is provided directly on the current collector, the expansion and contraction of the active material-containing layer in association with charging and discharging causes at least part of the active material-containing layer to peel away from the current collector. If at least part of the active material-containing layer peels away from the current collector, electron conduction paths inside the electrode decrease, and therefore the electrical resistance increases.

The electrode according to the embodiments is provided with an intermediate layer, which satisfies formula (1) above and has openings, between the current collector and the active material-containing layer. Because the intermediate layer contains a material having electrical conductivity, electrical conduction between the current collector and the active material-containing layer is not inhibited. If the intermediate layer satisfying formula (1) above is interposed between the current collector and the active material-containing layer, the component forming the active material-containing layer gets into the openings in the intermediate layer. For example, active material particles contained in the active material-containing layer may be present in the openings. By having the component forming the active material-containing layer get into the openings, the intermediate layer exhibits an anchor effect. Furthermore, at least part of the active material particles contained in the active material-containing layer can contact the current collector through the openings. As a result of these, the active material-containing layer becomes less likely to peel away from the current collector and the intermediate layer, and furthermore, direct conduction paths between the active material-containing layer and the current collector can be secured. The effect of improving peel strength by the anchor effect and the effect of securing direct conduction paths between the active material-containing layer and the current collector are not obtained with a solidly-applied intermediate layer that does not have openings.

Formula (1) above will be described. In formula (1), S is the ratio S_{B}/S_{A} of the total area S_{B} of the openings with respect to the unit area S_{A} in the intermediate layer. The unit area S_{A} in the intermediate layer means a unit area occupied by the portion where the intermediate layer is formed and also by at least one opening. In contrast, the total area S_{B} of the openings indicates a value obtained by totaling only the area of the openings. A method of measuring the unit area S_{A} in the intermediate layer and the total area S_{B} of the openings will be described later. In formula (1), r is the average primary particle size of the active material particles contained in the active material-containing layer. A method of measuring the average primary particle size of the active material particles will also be described later.

If the ratio S/r is within a range from 1 to 1700, the anchor effect of the active material-containing layer functions with respect to the openings in the intermediate layer, and therefore the active material-containing layer is less likely to peel away from the current collector and the intermediate layer. Consequently, in this case, because an increase in electrical resistance can be suppressed even after repeated charging and discharging, excellent cycle life properties can be achieved.

Ordinarily, when expansion and contraction of the active material-containing layer (active material particles) occur due to repeated charge-and-discharge cycles, as the number of cycles increases, the contraction of the active material-containing layer occurs less readily. In other words, the active material-containing layer remains expanded. Because the thickness of the expanded active material-containing layer is large, electrical resistances such as the contact resistance and the diffusion resistance are high.

However, the inventors discovered that with the electrode according to the embodiments, expansion of the active material-containing layer in the thickness direction is less likely to occur, even in the case of repeated charge-and-discharge cycles. Specifically, expansion of the active material-containing layer can be suppressed in not only the thickness direction but also in the in-plane direction. The reason for this is unclear, but it is thought that the anchor effect of the active material-containing layer with respect to the intermediate layer has an effect of causing the active material-containing layer itself to tighten. Therefore, because the expansion in the thickness direction and the in-plane direction (three-dimensional expansion) of the active material-containing layer during charging and discharging can be suppressed, excellent cycle life properties can be achieved, and in addition, an increase in electrical resistance can be suppressed.

In a case of using an active material that readily expands and contracts in volume by charging and discharging as the active material particles contained in the active material-containing layer, the effects described above are obtained relatively easily compared to the case of using an active material that does not readily expand and contract in volume.

In the case where the ratio S/r is less than 1, there are few points of contact between the active material and the current collector, for example, because of the small total area of the openings or the large average primary particle size of the active material particles. In this case, it can be said that the electrical resistance between the active material-containing layer and the current collector is in a high state. In this way, in the case where there are too few active material particles directly contacting the current collector and many active material particles touching the intermediate layer, the electrical resistance becomes high, which is not preferable. The reason for this is thought to be that although the intermediate layer contains a material having electrical conductivity, a comparison of the intermediate layer and the current collector demonstrates that the electron conductivity is higher for the current collector.

If the ratio S/r exceeds 1700, for example, the total area of the openings becomes too large and the anchor effect provided by the intermediate layer is not adequately obtained. For this reason, it is difficult to achieve excellent cycle life properties, and it is difficult to suppress an increase in electrical resistance.

The ratio S/r is preferably 1≤S/r≤1400, and more preferably 3≤S/r≤1100. The ratio S/r may also be 3≤S/r≤450.

Note that if the electrode is provided with the intermediate layer according to the embodiment, there is also an effect of suppressing corrosion of the current collector by electrolytes such as nonaqueous electrolytes.

Hereinafter, the electrode according to the embodiment will be described with reference to the drawings.

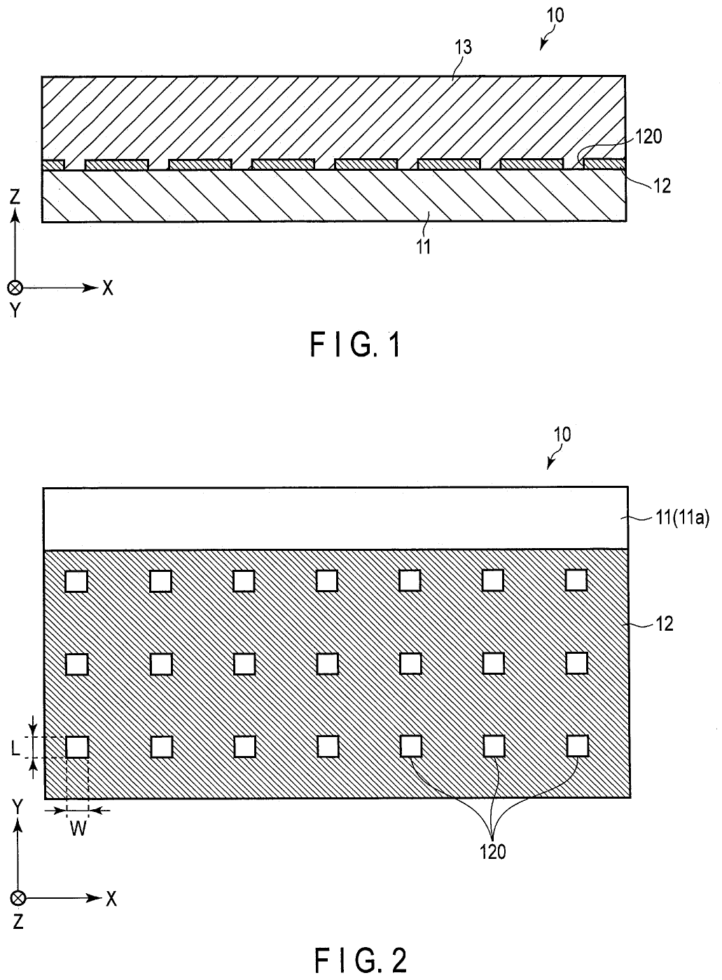

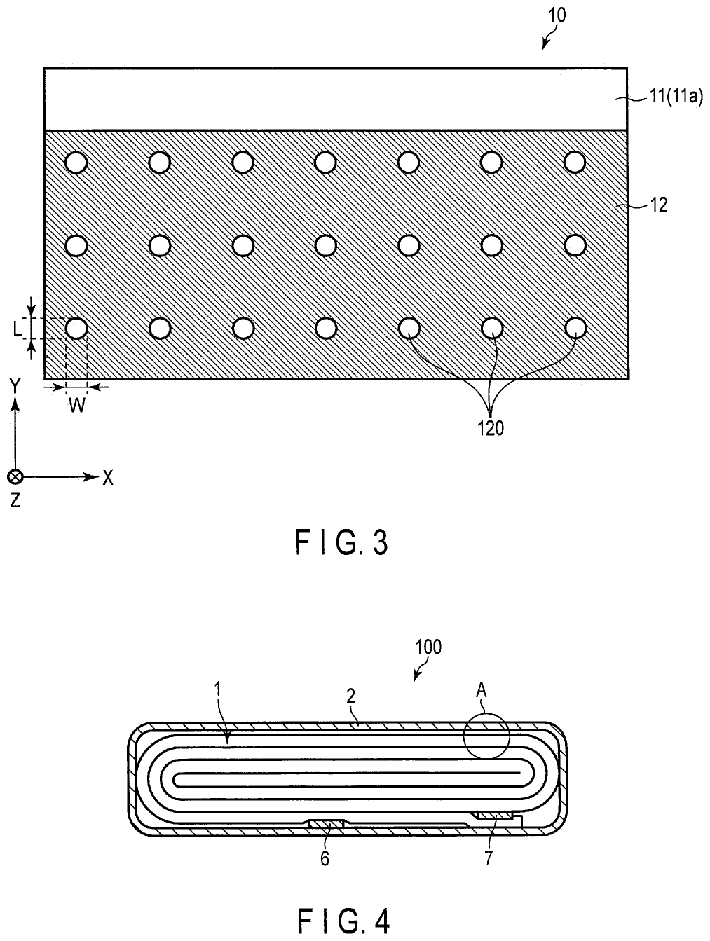

FIG. 1 is a cross-section view, cut in one direction, of one example of the electrode according to the embodiment. FIG. 2 is a cross-section view, cut in another direction, of one example of the electrode according to the embodiment. FIG. 3 is a cross-section view illustrating another example of the electrode according to the embodiment. In FIGS. 1 to 3, the X direction and the Y direction are parallel to the principal plane of a current collector 11 and also orthogonal to each other. The Z direction is perpendicular to the X and Y directions. In other words, the Z direction is the thickness direction of an electrode 10.

The electrode 10 illustrated in FIG. 1 is a laminate provided with a current collector 11, an intermediate layer 12, and an active material-containing layer 13, in this order. FIG. 1 illustrates a cross-section view cut along the thickness direction Z of the electrode 10. FIG. 2 illustrates a cross-section view cut along a direction orthogonal to the thickness direction of the electrode 10. FIG. 3 is a cross-section view illustrating a modification of the electrode illustrated in FIG. 2.

The current collector 11 is sheet-like metal foil, for example. As illustrated in FIG. 2, the current collector 11 can include a portion 11a where the intermediate layer 12 and the active material-containing layer 13 are not formed. This portion can work, for example, as a belt-shaped current collector tab 11a. The belt-shaped current collector tab 11a is provided with, for example, a long edge extending in the X direction and a short edge extending in the Y direction as illustrated in FIG. 2. The active material-containing layer 13 is a sheet-like layer that may be formed on one or both faces of the current collector via the intermediate layer 12. At least part of the active material-containing layer 13 is in direct contact with the current collector 11. The portion of the active material-containing layer 13 not in direct contact with the current collector 11 is in contact with the intermediate layer 12. The thickness of the active material-containing layer 13 is, for example, within a range from 20 μm to 80 μm. The active material-containing layer 13 contains active material particles. The active material-containing layer can optionally contain a conductive agent and a binder.

The electrode 10 may be provided with the intermediate layer 12 and the active material-containing layer 13 in this order on one face of the current collector 11, or may be provided with the intermediate layer 12 and the active material-containing layer 13 in this order on each of both faces of the current collector 11.

The intermediate layer 12 (undercoat layer) may be a sheet-like layer. The intermediate layer 12 contains a material having electrical conductivity. The material having electrical conductivity may be a simple substance or a compound. The intermediate layer 12 may also contain both a conductive simple substance and a conductive compound. The material having electrical conductivity is at least one selected from conductive inorganic matter and organic matter, for example. As the conductive inorganic matter, metal powders and/or oxides can be used. The material having electrical conductivity is preferably carbonaceous matter. As the carbonaceous matter, graphite, acetylene black, carbon black, carbon nanotubes, and the like can be used. The average primary particle size of the carbonaceous matter is within a range from 5 nm to 100 nm, for example.

The electrical conductivity of the material having electrical conductivity is 1×10⁸ S/m or greater for example, and is preferably 1×10⁶ S/m or greater. The intermediate layer 12 can contain a binder. The binder contained in the intermediate layer 12 may be, for example, a fluoride resin (such as PVDF), polyacrylic acid, an acrylic resin, a polyolefin resin, polyimide (PI), polyamide (PA), or polyamideimide (PAI).

The thickness of the intermediate layer 12 is 3 μm or less for example, and is preferably 1 μm or less.

The intermediate layer 12 has at least one opening 120, and satisfies the following formula (1).

1≤S/r≤1700 (1)

As described earlier, in formula (1), S is the ratio S_{B}/S_{A} of the total area of S_{B} the openings with respect to the unit area S_{A} in the intermediate layer. The unit area S_{A} in the intermediate layer indicates the total value of the areas of the intermediate layer and the openings. In contrast, the total area S_{B} of the openings indicates a value obtained by totaling only the area of the openings. In other words, S in formula (1) can also be called the opening ratio S.

The opening ratio S (the ratio S_{B}/S_{A}) is, for example, within a range from 0.001 to 0.9, and preferably within a range from 0.008 to 0.85. The opening ratio S may also be within a range from 0.008 to 0.4. In the case where the opening ratio S is too small, there is a possibility that the anchor effect provided by the intermediate layer 12 may not be adequately obtained. In this case, because the active material-containing layer 13 will peel readily due to repeated charge-and-discharge cycles, there is a possibility that achieving excellent cycle life properties and suppressing an increase in electrical resistance will become difficult. In the case where the opening ratio S is too large, there will be many portions where the active material-containing layer 13 is in direct contact with the current collector 11. Consequently, in this case, there is a possibility that the peel strength of the active material-containing layer 13 with respect to the current collector 11 and the intermediate layer 12 will be low. In other words, in this case there is likewise a possibility that the active material-containing layer 13 will peel readily due to repeated charge-and-discharge cycles, which is not preferable.

It is preferable for the intermediate layer according to the embodiment to additionally satisfy the following formula (2).

0.1≤S1/r≤1×10⁸ (2)

In formula (2), S1 is the average value of the area per at least one opening in the intermediate layer. Also, r is the average primary particle size of the active material particles contained in the active material-containing layer. Hereinafter, S1 may be abbreviated to the “per-opening area S1”. The ratio S1/r more preferably satisfies 1≤S1/r≤2×10⁶, and even more preferably satisfies 5≤S1/r≤300. If the ratio S1/r satisfies formula (2), at least part of the active material-containing layer is capable of getting into the openings, which has an effect of making the anchor effect of the intermediate layer manifest more readily.

<Method of Measuring Opening Ratio S and Per-Opening Area S1>

A method of measuring the opening ratio S and the per-opening area S1 will be described.

The presence or absence of the intermediate layer provided on the surface of the current collector can be confirmed by performing scanning electron microscopy (SEM) observation and elemental analysis by energy dispersive X-ray spectroscopy (EDX) with respect to the principal plane of the electrode. First, the battery in a fully discharged state (SOC 0%) is disassembled inside a glovebox filled with argon. From the disassembled battery, the electrode containing the intermediate layer to measure is retrieved. The electrode is washed with an appropriate solvent. A solvent such as ethyl methyl carbonate for example should be used as the solvent for washing. If the washing is insufficient, the intermediate layer may become difficult to observe in some cases due to the influence of residual lithium carbonate, lithium fluoride, and the like in the electrode.

The principal plane of the electrode (for example, the principal plane of the active material-containing layer) retrieved in this way is applied to a SEM stage such that the intermediate layer can be observed from the active material-containing layer side. At this time, conductive tape or the like is used to perform a treatment such that the electrode does not peel away or rise up from the stage. The electrode applied to the SEM stage is observed by scanning electron microscopy (SEM). Even during SEM measurement, it is preferable to introduce the electrode into the sample chamber while maintaining an inert atmosphere.

Ten locations are chosen randomly on the principal plane of the electrode, and SEM observation is performed at a magnification of 100×. By performing element mapping by EDX in conjunction with the observation by SEM at each observation point, the existence of portions where the current collector is exposed at the locations where the intermediate layer is not provided (that is, at the openings) can be confirmed. Furthermore, by use image processing to compute the ratio of the portions mapped as the current collector and the portions mapped as the intermediate layer, the opening ratio S at each observation point can be computed. When the opening ratio S of the intermediate layer is decided, the opening ratios S of the ten randomly chosen locations are computed, and then the average value of these is determined as the opening ratio S of the intermediate layer.

More specifically, at each observation point, the area of the entire field of view in the SEM image is determined as S_{A}, and the total area of one or more openings existing within the range of the field of view is determined as S_{B}. With this arrangement, the opening ratio (the ratio S_{B}/S at each observation point can be computed. The unit area S_{A} in the intermediate layer is within a range from 2.5×10⁻¹ mm² to 1.5 mm² for example. Also, the total area S_{B} of the openings existing in the SEM image is within a range from 2.1×10⁻³ mm² to 1.2 mm² for example. The total area S_{B} of the openings may also be within a range from 0.01 mm² to 0.50 mm².

Furthermore, at each of the ten observation points, the value of the per-opening area S1 is computed. In the case where a plurality of openings exists within the range of the field of view of an observation point, the average value of the area of the plurality of openings is computed as the per-opening area S1. Additionally, the average of the ten values computed at each of the ten observation points is determined as the per-opening area S1 for the intermediate layer.

The per-opening area S1 of the intermediate layer is, for example, within a range from 1×10⁻⁴ mm² to 100 mm², and is preferably within a range from 0.01 mm² to 1 mm². The per-opening area S1 may also be within a range from 0.01 mm² to 0.5 mm². If the per-opening area S1 is within this range, at least part of the active material-containing layer is capable of getting into the openings and the anchor effect of the intermediate layer manifests more readily, which is preferable.

The average primary particle size r of the active material particles contained in the active material-containing layer is not particularly limited, but is, for example, within a range from 0.5 μm to 5 μm, and preferably within a range from 0.8 μm to 2 μm.

<Method of Measuring Average Primary Particle Size of Active Material Particles>

As described hereinafter, the average primary particle size of the active material particles can be measured by using SEM to observe a cross-section of the electrode to be measured and also measuring a particle size distribution of the active material-containing layer.

First, the electrode to be measured is prepared similarly to the measurement method of the opening ratio S and the like described above. The prepared electrode is cut in the thickness direction with an ion milling machine. The electrode is applied to a SEM stage such that the cross-section of the cut electrode can be observed. At this time, conductive tape or the like is used to perform a treatment such that the electrode does not peel away or rise up from the stage. The electrode applied to the SEM stage is observed by scanning electron microscopy (SEM) at a magnification of 1000×. Even during SEM measurement, it is preferable to introduce the electrode into the sample chamber while maintaining an inert atmosphere.

By this observation, it is determined whether particles existing in a primary particle state or particles existing in a secondary particle state are more numerous as the active material particles contained in the active material-containing layer, and in addition, the value of the primary particle size is observed.

In addition, a particle size distribution of the active material-containing layer is measured according to the following procedure.

1. Disassembly of Secondary Battery

First, as advance preparations, gloves are worn to avoid touching the electrode and the electrolyte directly.

Next, to prevent the component elements of the battery from reacting with atmospheric components and moisture during disassembly, the secondary battery is inserted into a glovebox with an argon atmosphere. The secondary battery is opened inside the glovebox.

The electrode group is taken out of the opened secondary battery. In the case where the retrieved electrode group includes a positive electrode lead and a negative electrode lead, the positive electrode lead and the negative electrode lead are cut while taking care not to short the positive and negative electrodes. Next, the electrode group is disassembled to obtain a positive electrode or a negative electrode. The obtained electrode is washed using ethyl methyl carbonate. After washing, the electrode is subjected to vacuum drying. Alternatively, the electrode may be subjected to natural drying in an argon atmosphere.

2. Particle Size Distribution Measurement

The active material-containing layer is removed from the dried electrode using, for example, a spatula.

A sample of the removed active material-containing layer in powder form is loaded into a measurement cell filled with N-methyl-2-pyrrolidone until a measurable concentration is reached. Note that the capacity of the measurement cell and the measurable concentration differ depending on the particle size distribution measurement apparatus.

The measurement cell containing N-methyl-2-pyrrolidone and the active material-containing layer dispersed therein is irradiated with ultrasonic waves for 5 minutes. The output of the ultrasonic waves is within a range from 35 W to 45 W, for example. For example, in the case of using approximately 50 ml of N-methyl-2-pyrrolidone as a solvent, the solution in which the measurement sample is dispersed is irradiated with ultrasonic waves having an output of 40 W for 300 seconds. By such ultrasonic irradiation, the conductive agent particles and the active material particles can be disaggregated.

The measurement cell subjected to the ultrasonic treatment is fed into an apparatus that measures the particle size distribution by laser diffraction scattering, and the particle size distribution is measured. Examples of the particle size distribution measurement apparatus include the Microtrac 3100 and the Microtrac 300011, or an apparatus having substantially the same functionality as these apparatus. In this way, the particle size distribution of the active material-containing layer can be obtained.

A median diameter (D50) is computed from the obtained particle size distribution. By confirming that this value is approximately in agreement with the primary particle size of the active material particles observed by the SEM observation described above, the average primary particle size of the active material particles contained in the active material-containing layer can be determined.

Referring again to FIG. 2, the outer peripheral shape of the one or more openings 120 in the intermediate layer 12 is not particularly limited. Note that the outer peripheral shape of the openings 120 refers to the outer peripheral shape of the openings 120 in the case of observing the intermediate layer 12 from the normal direction (Z direction) of the principal surface of the electrode. The outer peripheral shape of the one or more openings 120 in the intermediate layer 12 is, for example, triangular, quadrangular, pentagonal, hexagonal, circular, or elliptical. In the case where the intermediate layer 12 has a plurality of openings, the outer peripheral shapes of the plurality of openings may be the same or different. For example, the intermediate layer 12 may have only a plurality of quadrangular openings 120 as illustrated in FIG. 2, or may have one or more quadrangular openings and one or more circular openings. As illustrated in FIG. 3, the intermediate layer 12 may also have only a plurality of circular openings 120.

FIGS. 2 and 3 illustrate a dimension W in the X direction and a dimension L in the Y direction for the one or more openings 120 in the intermediate layer 12. The ratio W/L of these dimensions is, for example, within a range from 0.6 to 1.4, and preferably within a range from 0.9 to 1.1. The ratio W/L may be equal or substantially equal to 1. In this case where this ratio is greater than 1, that is, in the case where W>L, the shape of the openings 120 may be rectangle with long side in the X direction. In the case where the shape of the openings 120 is rectangle, there is a possibility that the amount of expansion in the X direction of the active material-containing layer 13 will be different from the amount of expansion in the Y direction. In this case, when the electrode is subjected to charge-and-discharge cycles, there is a possibility that the electrode will not degrade uniformly and have poor cycle life properties, which is not preferable. For a similar reason, the case where the above ratio W/L is less than 1 is not preferable. In other words, the above ratio is preferably close to 1.

The dimension W in the X direction and the dimension L in the Y direction can be determined by SEM observation performed when the opening ratio S is measured. Specifically, when the dimensions of the openings 120 are measured in a direction parallel to the X direction in which the long edge of the current collector tab 11a extends, the dimension of the openings 120 at a position where the dimension is the largest is treated as the dimension W. On the other hand, when the dimensions of the openings 120 are measured in a direction parallel to the Y direction that is orthogonal to the X direction, the dimension of the openings 120 at a position where the dimension is the largest is treated as the dimension L. This measurement is performed for ten arbitrarily chosen openings 120, and the average of the value of the ratio W/L obtained for each of the openings 120 is computed and taken to be the final value of the ratio W/L.

The electrode according to the embodiments may be a negative electrode or a positive electrode. The electrode according to the embodiments may be an electrode for a secondary battery. Hereinafter, the case where the electrode according to the embodiments is a negative electrode and the case of a positive electrode will be described separately, and a detailed description of the materials forming these types of electrodes and the like will be given. First, a negative electrode will be described.

A negative electrode can have a negative electrode current collector and an intermediate layer as well as a negative electrode active material-containing layer supported on one or both faces of the negative electrode current collector. The negative electrode active material-containing layer additionally can contain a conductive agent and a binder.

The negative electrode current collector may be made of a material electrochemically stable at potentials for lithium insertion and extraction in the negative electrode active material. The negative electrode current collector may preferably be made of an aluminum alloy containing copper, nickel, stainless steel, or aluminum, or one or more selected from Mg, Ti, Zn, Mn, Fe, Cu, and Si. The negative electrode current collector may preferably have a thickness in the range of 5 μm to 20 μm. The negative electrode current collector having such a thickness may allow the negative electrode to achieve both strength and weight reduction in a well-balanced manner.

As the negative electrode active material, those capable of allowing lithium ions to be inserted thereinto and extracted therefrom can be used, and examples thereof can include a carbon material, a graphite material, a lithium alloy material, a metal oxide, and a metal sulfide. The negative electrode active material preferably contains a titanium oxide whose insertion and extraction potential of lithium ion is within a range of 1 V to 3 V (vs. Li/Li⁺).

Examples of the titanium oxide include lithium titanate (for example, Li_{2+y}Ti₃O₇, 0≤y≤3) having a ramsdellite structure, lithium titanate (for example, Li₄₊ₓTi₅O₁₂, 0≤x≤3) having a spinel structure, monoclinic titanium dioxide (TiO₂), anatase titanium dioxide, rutile titanium dioxide, a hollandite titanium composite oxide, an orthorhombic titanium-containing composite oxide, and a monoclinic niobium titanium composite oxide.

An example of the orthorhombic titanium-containing composite oxide is a compound represented by Li₂₊ₐM(I)_{2-b}Ti_{6-c}M(II)_{d}O_{14+σ}. Here, M(I) is at least one selected from the group consisting of Sr, Ba, Ca, Mg, Na, Cs, Rb, and K. M(II) is at least one selected from the group consisting of Zr, Sn, V, Nb, Ta, Mo, W, Y, Fe, Co, Cr, Mn, Ni, and Al. Each subscript in the composition formulas is given such that 0≤a≤6, 0≤b≤2, 0≤c<6, 0≤d<6, and −0.5≤σ≤0.5. A specific example of the orthorhombic titanium-containing composite oxide is Li_{2|a}Na₂Ti₆O₁₄ (0≤a≤6).

An example of the monoclinic niobium titanium composite oxide is a compound represented by LiₓTi_{1-y}M1_{y}Nb_{2-z}M2_{z}O_{7+δ}. Here, M1 is at least one selected from the group consisting of Zr, Si, and Sn. M2 is at least one selected from the group consisting of V, Ta, and Bi. Each subscript in the composition formulas is given such that 0≤x≤5, 0≤y≤1, 0≤z<2, and −0.3<δ≤0.3. A specific example of the monoclinic niobium titanium composite oxide is LiₓNb₂TiO₇ (0≤x≤5).

Another example of the monoclinic niobium titanium composite oxide is a compound represented by Ti_{1-y}M3_{y+z}Nb_{2-z}O_{7-δ}. Here, M3 is at least one selected from the group consisting of Mg, Fe, Ni, Co, W, Ta, and Mo. Each subscript in the composition formulas is given such that 0≤y<1, 0≤z≤2, and −0.3≤δ≤0.3.

The negative electrode active material particles may be lone primary particles, secondary particles which are aggregates of primary particles, or a mixture of lone primary particles and secondary particles. The negative electrode active material-containing layer preferably contains 50% or more primary particles by volume. When the content percentage of primary particles is within this range, electron conduction paths between the active material-containing layer and the current collector as well as the intermediate layer can be formed favorably, which is preferable. Examples of the shape of the primary particles may include but are not limited to spherical, ellipsoidal, flat, and fiber-like shapes.

The negative electrode active material particles may preferably have an average primary particle size in the range of 0.1 μm to 1 μm, and their specific surface area according to the BET method using N₂ adsorption may preferably be in the range of 3 m²/g to 200 m²/g. This may enhance affinity with the electrolyte. The negative electrode active material particles may more preferably have an average primary particle size in the range of 0.5 μm to 1 μm.

A conductive agent is added in order to increase the current-collecting performance and suppress the contact resistance between the active material and the current collector. Examples of the conductive agent include carbonaceous materials such as vapor grown carbon fiber (VGCF) and carbon black. Examples of the carbon black include acetylene black and graphite. One of these materials may be used as the conductive agent, or two or more of these materials may be combined and used as the conductive agent. Alternatively, instead of using the conductive agent, carbon coating or electron conductive inorganic material coating may be performed on the surfaces of the active material particles.

In the negative electrode provided with the intermediate layer according to the embodiment, even if a carbon coating or an electronically conductive inorganic material coating of the surfaces of the active material particles is omitted, excellent electronic conductivity between the current collector and the active material-containing layer can be secured.

A binder is added in order to fill a gap between dispersed active materials and bind the active material and the negative electrode current collector. Examples of the binder include polytetrafluoroethylene (PTFE), polyvinylidene fluoride (PVDF), fluorine rubber, styrene butadiene rubber, polyacrylic acid compound, imide compound, carboxymethyl cellulose (CMC), and salts of the CMC. One of these materials may be used as the binder, or two or more of these materials may be combined and used as the binder.

The negative electrode may preferably have a porosity (excluding the current collector) ranging from 20% to 50%. Such porosity may provide a negative electrode that excels in affinity with electrolyte and attains a higher density. A more preferable range of the porosity may be 25% to 40%.

The combination ratio of the active material, the conductive agent, and the binder in the negative electrode active material-containing layer can be changed appropriately according to the use of the negative electrode. For example, in the case of using the electrode as the negative electrode of a secondary battery, it is preferable to combine the above in a mass ratio of the active material (negative electrode active material) in a range from 68% to 96%, the conductive agent in a range from 2% to 30%, and the binder in a range from 2% to 30%. By making the amount of the conductive agent be 2% by mass or greater, the current-collecting performance of the active material-containing layer can be improved. Also, by making the amount of the binder be 2% by mass or greater, the binding between the active material-containing layer and the current collector becomes sufficient, and excellent cycle performance can be expected. On the other hand, keeping each of the conductive agent and the binder to 30% by mass or less is preferable to attain higher capacity.

The negative electrode can be produced according to the following method, for example. First, the material having electrical conductivity and the binder are dispersed in an appropriate solvent such as N-methyl-2-pyrrolidone (NMP) to prepare a slurry for producing the intermediate layer. The slurry is applied to the current collector. The application method is not particularly limited, and may be for example, application by gravure printing. With gravure printing, an intermediate layer having at least one opening and satisfying formula (1) described earlier can be formed. In gravure printing, a gravure roll having grooves formed, for example, in a lattice is used. By suitably adjusting features such as the width of the grooves, the spacing of the grooves, the depth of the grooves, and the shape of the grooves in the gravure roll, an intermediate layer having the desired opening area and opening shape can be produced. In other words, by adjusting the width of the grooves and the spacing of the grooves in the gravure roll, the total area S_{B} of the openings and the area per opening S1 can be adjusted. The width of the grooves in the gravure roll is set, for example, within a range from 10 μm to 10 mm, the spacing of the grooves is set, for example, within a range from 10 μm to 10 mm, and the depth of the grooves is set, for example, within a range from 1 μm to 100 μm. After applying the slurry, the slurry is dried to form the intermediate layer.

Next, a slurry for forming the active material-containing layer is prepared. The slurry is prepared by suspending the negative electrode active material particles, the conductive agent, and the binder in an appropriate solvent. By applying the slurry to the negative electrode current collector and the intermediate layer and then drying, a laminate in which the negative electrode current collector, the intermediate layer, and the negative electrode active material-containing layer are laminated in this order is obtained. By pressing the laminate, the negative electrode according to the embodiments is produced.

Next, the case where the electrode according to the embodiment is a positive electrode will be described.

A positive electrode can have a positive electrode current collector and an intermediate layer as well as a positive electrode active material-containing layer supported on one or both faces of the positive electrode current collector. The positive electrode active material-containing layer additionally can contain a conductive agent and a binder.

The positive electrode current collector is preferably an aluminum foil or an aluminum alloy foil containing one or more elements selected from Mg, Ti, Zn, Ni, Cr, Mn, Fe, Cu, and Si.

A thickness of the aluminum foil or the aluminum alloy foil is preferably from 5 μm to 20 μm, and more preferably from 5 μm to 15 μm. A purity of the aluminum foil is preferably 99% by mass or more. A content of transition metals such as iron, copper, nickel, and chromium contained in the aluminum foil or the aluminum alloy foil is preferably 1% by mass or less.

Examples of the positive electrode active material include oxides and sulfides having lithium ion conductivity. The positive electrode may include, as the positive electrode active material, one type of compound or two or more different types of compounds. Examples of the oxides and the sulfides may include compounds allowing lithium or lithium ions to be inserted thereinto or extracted therefrom.

Examples of such compounds include manganese dioxides (MnO₂), iron oxides, copper oxides, nickel oxides, lithium manganese composite oxides (e.g., LiₓMn₂O₄ or LiₓMnO₂; 0<x≤1), lithium nickel composite oxides (e.g., LiₓNiO₂; 0<x≤1), lithium cobalt composite oxides (e.g., LiₓCoO₂; 0<x≤1), lithium nickel cobalt composite oxides (e.g., LiₓNi_{1-y}Co_{y}O₂; 0<x≤1, 0<y<1), lithium manganese cobalt composite oxides (e.g., LiₓMn_{y}Co_{1-y}O₂; 0<x≤1, 0<y<1), lithium manganese nickel composite oxides having a spinel structure (e.g., LiₓMn_{2-y}Ni_{y}O₄; 0<x≤1, 0<y<2), lithium phosphates having an olivine structure (e.g., LiₓFePO₄; 0<x≤1, LiₓFe_{1-y}Mn_{y}PO₄; 0<x≤1, 0<y<1, and LiₓCoPO₄; 0<x≤1), iron sulfates [Fe₂(SO₄)₃], vanadium oxides (e.g., V₂O₅), and lithium nickel cobalt manganese composite oxides (LiₓNi_{1-y-z}Co_{y}Mn_{z}O₂; 0<x≤1, 0<y<1, 0<z<1, y+z<1).

Among the above, examples of compounds more preferable as the positive electrode active material include lithium manganese composite oxides having a spinel structure (e.g., LiₓMn₂O₄; 0<x≤1), lithium nickel composite oxides (e.g., LiₓNiO₂; 0<x≤1), lithium cobalt composite oxides (e.g., LiₓCoO₂; 0<x≤1), lithium nickel cobalt composite oxides (e.g., LiₓNi_{1-y}Co_{y}O₂; 0<x≤1, 0<y<1), lithium manganese nickel composite oxides having a spinel structure (e.g., LiₓMn_{2-y}Ni_{y}O₄; 0<x≤1, 0<y<2), lithium manganese cobalt composite oxides (e.g., LiₓMn_{y}Co_{1-y}O₂; 0<x≤1, 0<y<1), lithium iron phosphates (e.g., LiₓFePO₄; 0<x≤1), and lithium nickel cobalt manganese composite oxides (LiₓNi_{1-y-z}Co_{y}Mn_{z}O₂; 0<x≤1, 0<y<1, 0<z<1, y+z<1). The positive electrode potential can be made high by using these positive electrode active materials.

When a room temperature molten salt is used as the electrolyte of the battery, it is preferable to use a positive electrode active material including lithium iron phosphate, LiₓVPO₄F (0≤x≤1), lithium manganese composite oxide, lithium nickel composite oxide, lithium nickel cobalt composite oxide, or a mixture thereof. Since these compounds have low reactivity with room temperature molten salts, cycle life can be improved. Details regarding the room temperature molten salt are described later.

The positive electrode active material may preferably have primary particle sizes in the range of 100 nm to 1 μm. The positive electrode active material having primary particle sizes of 100 nm or more may be easy to handle in industrial applications. The positive electrode active material having primary particle sizes of 1 μm or less may allow lithium ions to be smoothly diffused in solid.

The positive electrode active material particles may be lone primary particles, secondary particles which are aggregates of primary particles, or a mixture of lone primary particles and secondary particles. The positive electrode active material-containing layer preferably contains 50% or more primary particles by volume. If the content percentage of primary particles is within this range, electron conduction paths between the active material-containing layer and the current collector as well as the intermediate layer can be formed favorably, which is preferable. Examples of the shape of the primary particles may include but are not limited to spherical, ellipsoidal, flat, and fiber-like shapes.

The positive electrode active material may preferably have a specific surface area in the range of 0.1 m²/g to 10 m²/g. The positive electrode active material having a specific surface area of 0.1 m²/g or more may secure an adequately large site for insertion and extraction of Li ions. The positive electrode active material having a specific surface area of 10 m²/g or less may be easy to handle in industrial applications and may ensure a favorable charge-and-discharge cycle.

A binder is added in order to fill a gap between dispersed positive electrode active materials and to bind the positive electrode active material and the positive electrode current collector. Examples of the binder include polytetrafluoroethylene (PTFE), polyvinylidene fluoride (PVDF), fluorine rubber, polyacrylic acid compound, imide compound, carboxyl methyl cellulose (CMC), and salts of the CMC. One of these materials may be used as the binder, or two or more of these materials may be combined and used as the binder.

A conductive agent is added in order to increase the current-collecting performance and suppress the contact resistance between the positive electrode active material and the positive electrode current collector. Examples of the conductive agent include carbonaceous matters such as vapor grown carbon fiber (VGCF) and carbon black. Examples of the carbon black include acetylene black and graphite. One of these materials may be used as the conductive agent, or two or more of these materials may be combined and used as the conductive agent. In addition, the conductive agent can be omitted. Alternatively, instead of using the conductive agent, carbon coating or electron conductive inorganic material coating may be performed on the surfaces of the active material particles.

In the positive electrode provided with the intermediate layer according to the embodiment, even if a carbon coating or an electronically conductive inorganic material coating is omitted from the surfaces of the active material particles, excellent electronic conductivity between the current collector and the active material-containing layer can be secured.

In the positive electrode active material-containing layer, it is preferable to combine the positive electrode active material and the binder in a mass ratio of the positive electrode active material in a range from 80% to 98% and the binder in a range from 2% to 20%.

By making the amount of the binder be 2% by mass or greater, sufficient electrode strength is obtained. In addition, the binder may function as an insulator. For this reason, if the amount of the binder is kept at 20% by mass or less, the amount of insulation contained in the electrode is decreased, and therefore the internal resistance can be reduced.

In the case of adding the conductive agent, it is preferable to combine the positive electrode active material, the binder, and the conductive agent in a mass ratio of the positive electrode active material in a range from 77% to 95%, the binder in a range from 2% to 20%, and conductive agent in a range from 3% to 15%.

By making the amount of the conductive agent be 3% by mass or greater, the effects described above can be exhibited. Also, by keeping the amount of the conductive agent to 15% by mass or less, the proportion of the conductive agent in contact with electrolyte can be lowered. If this proportion is low, decomposition of the electrolyte under high-temperature storage can be reduced. The positive electrode can be produced according to the following method, for example. First, the material having electrical conductivity and the binder are dispersed in an appropriate solvent such as N-methyl-2-pyrrolidone (NMP) to prepare a slurry for producing the intermediate layer. The slurry is applied to the current collector. The application method is not particularly limited, and may be for example, application by gravure printing. With gravure printing, an intermediate layer having at least one opening and satisfying formula (1) described earlier can be formed. In gravure printing, a gravure roll having grooves formed, for example, in a lattice is used. By suitably adjusting features such as the width of the grooves, the spacing of the grooves, the depth of the grooves, and the shape of the grooves in the gravure roll, an intermediate layer having the desired opening area and opening shape can be produced. In other words, by adjusting the width of the grooves and the spacing of the grooves in the gravure roll, the total area S_{B} of the openings and the area per opening S1 can be adjusted. The width of the grooves in the gravure roll is set, for example, within a range from 10 μm to 10 mm, the spacing of the grooves is set, for example, within a range from 10 μm to 10 mm, and the depth of the grooves is set, for example, within a range from 1 μm to 100 μm. After applying the slurry, the slurry is dried to form the intermediate layer.

Next, a slurry for forming the active material-containing layer is prepared. The slurry is prepared by suspending the positive electrode active material particles, the conductive agent, and the binder in an appropriate solvent. By applying the slurry to the positive electrode current collector and the intermediate layer and then drying, a laminate in which the positive electrode current collector, the intermediate layer, and the positive electrode active material-containing layer are laminated in this order is obtained. By pressing the laminate, the positive electrode according to the embodiments is produced.

According to the first embodiment, an electrode is provided. The electrode includes a current collector, an intermediate layer containing a material having electrical conductivity, and an active material-containing layer containing active material particles, in this order. The intermediate layer includes at least one opening and also satisfies the following formula (1).

1≤S/r≤1700 (1)

In formula (1) above, S is the ratio S_{B}/S_{A} of the total area S_{B} of the at least one opening with respect to a unit area S_{A} in the intermediate layer, and r is an average primary particle size of the active material particles.

For this reason, with the electrode according to the first embodiment, a secondary battery having excellent cycle life properties and capable of suppressing an increase in electrical resistance can be achieved.

### Second Embodiment

According to the second embodiment, a secondary battery including the electrode according to the first embodiment and an electrolyte is provided. The secondary battery includes a negative electrode, a positive electrode, and an electrolyte. The secondary battery may include the electrode according to the first embodiment as the negative electrode or as the positive electrode. The secondary battery may include the negative electrode according to the first embodiment, the positive electrode according to the first embodiment, and an electrolyte.

The secondary battery additionally can be equipped with a separator disposed between the positive electrode and the negative electrode. The negative electrode, the positive electrode, and the separator can form an electrode group. The electrolyte may be held in the electrode group.

Also, the secondary battery according to the embodiment additionally can be equipped with a container member that houses the electrode group and the electrolyte.

Furthermore, the secondary battery according to the embodiment additionally can be equipped with a negative electrode terminal electrically connected to the negative electrode and a positive electrode terminal electrically connected to the positive electrode.

The secondary battery according to the embodiment may be a lithium secondary battery, for example. The secondary battery includes a nonaqueous electrolyte secondary battery containing a nonaqueous electrolyte.

Hereinafter, a detailed description is given to the negative electrode, positive electrode, electrolyte, separator, container member, negative electrode terminal, and positive electrode terminal.

(1) Negative Electrode

The negative electrode provided in the secondary battery according to the second embodiment may be the negative electrode described in the first embodiment. When the positive electrode used is configured as described in the first embodiment, it may be unnecessary for the negative electrode to include the intermediate layer.

(2) Positive Electrode

The positive electrode provided in the secondary battery according to the second embodiment may be the positive electrode described in the first embodiment. When the negative electrode used is configured as described in the first embodiment, it may be unnecessary for the positive electrode to include the intermediate layer.

(3) Electrolyte

Examples of the electrolyte may include nonaqueous liquid electrolyte or nonaqueous gel electrolyte. The nonaqueous liquid electrolyte may be prepared by dissolving an electrolyte salt used as solute in an organic solvent. The electrolyte salt may preferably have a concentration in the range of 0.5 mol/L to 2.5 mol/L.

Examples of the electrolyte salt include lithium salts such as lithium perchlorate (LiClO₄), lithium hexafluorophosphate (LiPF₆), lithium tetrafluoroborate (LiBF₄), lithium hexafluoroarsenate (LiAsF₆), lithium trifluoromethanesulfonate (LiCF₃SO₃), and lithium bistrifluoromethylsulfonylimide [LiN(CF₃SO₂)₂], and mixtures thereof. The electrolyte salt is preferably resistant to oxidation even at a high potential, and most preferably LiPF₆.

Examples of the organic solvent include cyclic carbonates such as propylene carbonate (PC), ethylene carbonate (EC), or vinylene carbonate (VC); linear carbonates such as diethyl carbonate (DEC), dimethyl carbonate (DMC), or methyl ethyl carbonate (MEC); cyclic ethers such as tetrahydrofuran (THF), 2-methyl tetrahydrofuran (2-NeTHF), or dioxolane (DOX); linear ethers such as dimethoxy ethane (DME) or diethoxy ethane (DEE); γ-butyrolactone (GBL), acetonitrile (AN), and sulfolane (SL). These organic solvents may be used singularly or as a mixed solvent.

The gel nonaqueous electrolyte is prepared by obtaining a composite of a liquid nonaqueous electrolyte and a polymeric material. Examples of the polymeric material include polyvinylidene fluoride (PVDF), polyacrylonitrile (PAN), polyethylene oxide (PEO), and mixtures thereof.

Alternatively, besides the nonaqueous liquid electrolyte and the nonaqueous gel electrolyte, a room-temperature molten salt (ionic melt) containing lithium ions, a polymer solid electrolyte, an inorganic solid electrolyte, and the like may also be used as the nonaqueous electrolyte.

The room temperature molten salt (ionic melt) indicates compounds among organic salts made of combinations of organic cations and anions, which are able to exist in a liquid state at room temperature (15° C. to 25° C.). The room temperature molten salt includes a room temperature molten salt which exists alone as a liquid, a room temperature molten salt which becomes a liquid upon mixing with an electrolyte salt, a room temperature molten salt which becomes a liquid when dissolved in an organic solvent, and mixtures thereof. In general, the melting point of the room temperature molten salt used in secondary batteries is 25° C. or below. The organic cations generally have a quaternary ammonium framework.

A polymer solid electrolyte is prepared by dissolving an electrolyte salt into a polymer material and solidifying the result.

An inorganic solid electrolyte is solid material having Li-ion conductivity.

The electrolyte may also be an aqueous electrolyte containing water.

The aqueous electrolyte includes an aqueous solvent and an electrolyte salt. The aqueous electrolyte is liquid, for example. A liquid aqueous electrolyte is an aqueous solution prepared by dissolving an electrolyte salt as the solute in an aqueous solvent. The aqueous solvent is a solvent containing 50% or more water by volume, for example. The aqueous solvent may also be pure water.

The aqueous electrolyte may also be an aqueous gel composite electrolyte containing an aqueous electrolytic solution and a polymer material. The polymer material may be, for example, polyvinylidene fluoride (PVDF), polyacrylonitrile (PAN), or polyethylene oxide (PEO).

The aqueous electrolyte preferably contains 1 mol or greater of aqueous solvent per 1 mol of the salt as the solute. In an even more preferably aspect, the aqueous electrolyte contains 3.5 mol or greater of aqueous solvent per 1 mol of the salt as the solute.

That the aqueous electrolyte contains water can be confirmed by gas chromatography-mass spectrometry (GC-MS) measurement. Also, the salt concentration and the amount of water contained in the aqueous electrolyte can be computed by measurement using inductively coupled plasma (ICP) emission spectroscopy or the like, for example. By measuring out a prescribed amount of the aqueous electrolyte and computing the contained salt concentration, the molar concentration (mol/L) can be computed. Also, by measuring the specific gravity of the aqueous electrolyte, the number of moles of the solute and the solvent can be computed.

The aqueous electrolyte is prepared by dissolving the electrolyte salt into the aqueous solvent at a concentration from 1 to 12 mol/L for example.

To suppress electrolysis of the aqueous electrolyte, LiOH, Li₂SO₄, or the like can be added to adjust the pH. The pH is preferably from 3 to 13, and more preferably from 4 to 12.

(4) Separator

The separator may include a porous film made of polyethylene (PE), polypropylene (PP), cellulose, or polyvinylidene fluoride (PVDF), or include an unwoven fabric made of a synthetic resin. Preferably, a porous film made of polyethylene or polypropylene may be used in terms of safety. The porous film made of such a material may dissolve at a certain temperature and block electric current.

(5) Container Member

As the container member, for example, a container made of laminate film or a container made of metal may be used.

The thickness of the laminate film is, for example, 0.5 mm or less, and preferably 0.2 mm or less.

As the laminate film, used is a multilayer film including multiple resin layers and a metal layer sandwiched between the resin layers. The resin layer may include, for example, a polymeric material such as polypropylene (PP), polyethylene (PE), nylon, or polyethylene terephthalate (PET). The metal layer is preferably made of aluminum foil or an aluminum alloy foil, so as to reduce weight. The laminate film may be formed into the shape of a container member, by heat-sealing.

The wall thickness of the metal container is, for example, 1 mm or less, more preferably 0.5 mm or less, and still more preferably 0.2 mm or less.

The metal case is made, for example, of aluminum or an aluminum alloy. The aluminum alloy preferably contains elements such as magnesium, zinc, or silicon. If the aluminum alloy contains a transition metal such as iron, copper, nickel, or chromium, the content thereof is preferably 100 ppm by mass or less.

The shape of the container member is not particularly limited. The shape of the container member may be, for example, flat (thin), square, cylinder, coin, or button-shaped. The container member may be appropriately selected depending on battery size and use of the battery.

(6) Negative Electrode Terminal

The negative electrode terminal may be made of a material that is electrochemically stable at the potential at which Li is inserted into and extracted from the above-described negative electrode active material, and has electrical conductivity. Specific examples of the material for the negative electrode terminal include copper, nickel, stainless steel, aluminum, and aluminum alloy containing at least one element selected from the group consisting of Mg, Ti, Zn, Mn, Fe, Cu, and Si. Aluminum or aluminum alloy is preferred as the material for the negative electrode terminal. The negative electrode terminal is preferably made of the same material as the negative electrode current collector, in order to reduce the contact resistance with the negative electrode current collector.

(7) Positive Electrode Terminal

The positive electrode terminal may be made of, for example, a material that is electrically stable in the potential range of 3 V to 5 V (vs. Li/Li⁺) relative to the redox potential of lithium, and has electrical conductivity. Examples of the material for the positive electrode terminal include aluminum and an aluminum alloy containing one or more selected from the group consisting of Mg, Ti, Zn, Mn, Fe, Cu, and Si. The positive electrode terminal is preferably made of the same material as the positive electrode current collector, in order to reduce contact resistance with the positive electrode current collector.

Next, the secondary battery according to the embodiment will be described in detail with reference to the drawings.

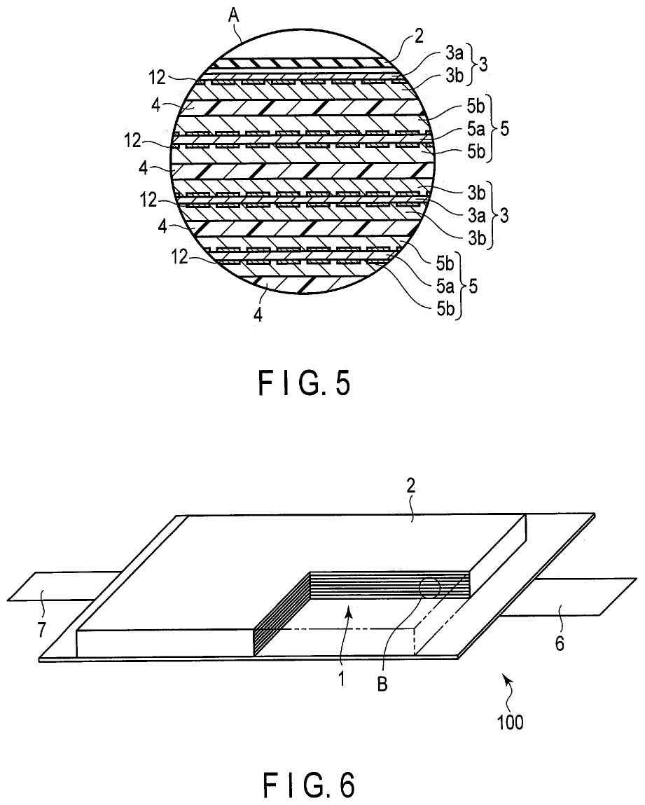

FIG. 4 is a sectional view schematically showing an example of a secondary battery according to an embodiment. FIG. 5 is an enlarged sectional view of a portion A of the secondary battery shown in FIG. 4.

The secondary battery 100 shown in FIG. 4 and FIG. 5 includes a bag-shaped container member 2 shown in FIG. 4, an electrode group 1 shown in FIG. 4 and FIG. 5, and an electrolyte (not shown). The electrode group 1 and the electrolyte are stored in the bag-shaped container member 2. The electrolyte (not shown) is held in the electrode group 1.

The bag-shaped container member 2 is formed from a laminate film including two resin layers and a metal layer disposed therebetween.

As shown in FIG. 4, the electrode group 1 is a flat wound electrode group. The flat wound electrode group 1 includes negative electrodes 3, separators 4, and positive electrodes 5 as shown in FIG. 5. The separator 4 is disposed between the negative electrode 3 and the positive electrode 5.

A negative electrode 3 includes a negative electrode current collector 3a, an intermediate layer 12, and negative electrode active material-containing layers 3b. In the portion of the negative electrode 3 located at the outermost shell of a wound electrode group 1, the intermediate layer 12 and the negative electrode active material-containing layer 3b is formed in this order only on the inside surface side of the negative electrode current collector 3a, as shown in FIG. 5. In another portion of the negative electrode 3, the intermediate layer 12 and the negative electrode active material-containing layer 3b is formed in this order on both sides of the negative electrode current collector 3a.

A positive electrode 5 includes a positive electrode current collector 5a, the intermediate layer 12, and a positive electrode active material-containing layer 5b. The intermediate layer 12 and the positive electrode active material-containing layer 5b are formed in this order on each of both faces of the positive electrode current collector 5a.

As shown in FIG. 4, a negative electrode terminal 6 and a positive electrode terminal 7 are positioned near the outer end of the wound electrode group 1. The negative electrode terminal 6 is connected to the outermost part of the negative electrode current collector 3a. In addition, the positive electrode terminal 7 is connected to the outermost part of the positive electrode current collector 5a. The negative electrode terminal 6 and the positive electrode terminal 7 extend outward from opening portions of the bag-shaped container member 2. A thermoplastic resin layer is provided on the inner surface of the bag-shaped container member 2, and the opening of the bag-shaped container member 2 are closed by thermal fusion bonding of the thermoplastic resin layer.

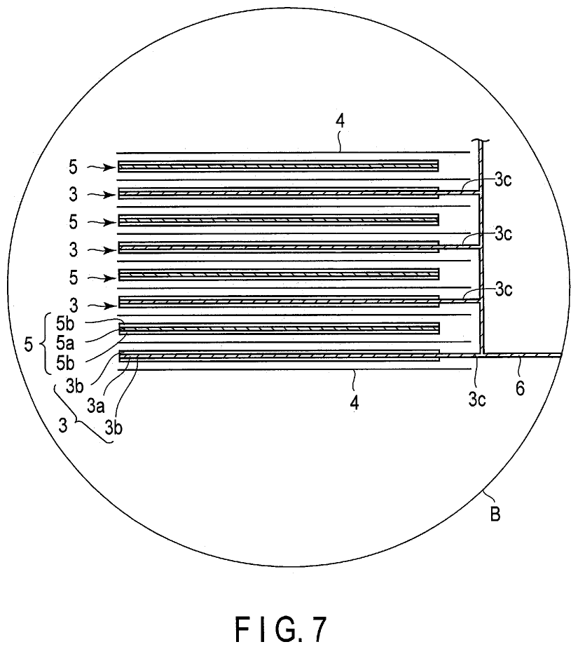

The secondary battery according to the embodiment is not limited to the secondary battery having the structure shown in FIGS. 4 and 5, and may be, for example, a battery having a structure shown in FIGS. 6 and 7.

FIG. 6 is a partial cut-away sectional perspective view schematically showing another example of the secondary battery according to the embodiment. FIG. 7 is an enlarged sectional view of a portion B of the secondary battery shown in FIG. 6.

The secondary battery 100 shown in FIGS. 6 and 7 includes an electrode group 1 shown in FIGS. 6 and 7, a container member 2 shown in FIG. 6, and an electrolyte (not shown). The electrode group 1 and the electrolyte are stored in the container member 2. The electrolyte is held in the electrode group 1.

The container member 2 is made of a laminate film including two resin layers and a metal layer intervening therebetween.

As shown in FIG. 7, the electrode group 1 is a laminated electrode group. The laminated electrode group 1 has a structure in which a negative electrode 3 and a positive electrode 5 are alternately laminated with a separator 4 intervening therebetween.

The electrode group 1 includes a plurality of the negative electrodes 3. Although omitted from illustration in FIG. 7, the intermediate layer 12 and the negative electrode active material-containing layer 3b are formed in this order on each of both faces of the negative electrode current collector 3a included in the negative electrode 3.

Also, the electrode group 1 includes a plurality of the positive electrodes 5. Although omitted from illustration in FIG. 7, the intermediate layer 12 and the positive electrode active material-containing layer 5b are formed in this order on each of both faces of the positive electrode current collector 5a included in the positive electrode 5.

The negative electrode current collector 3a of each negative electrode 3 includes a portion 3c on one side where the intermediate layer 12 and the negative electrode active material-containing layer 3b are not carried on any surfaces. This portion 3c acts as a negative electrode tab. As shown in FIG. 7, the portion 3c acting as the negative electrode tab does not overlap the positive electrode 5. In addition, a plurality of negative electrode tabs (portion 3c) is electrically connected to a belt-shaped negative electrode terminal 6. A tip of the belt-shaped negative electrode terminal 6 is drawn outward from a container member 2.

In addition, although not shown, the positive electrode current collector 5a of each positive electrode 5 includes a portion on one side where the intermediate layer 12 and the positive electrode active material-containing layer 5b are not carried on any surfaces. This portion acts as a positive electrode tab. Like the negative electrode tab (portion 3c), the positive electrode tab does not overlap the negative electrode 3. In addition, the positive electrode tab is positioned on the opposite side of the electrode group 1 with respect to the negative electrode tab (portion 3c). The positive electrode tab is electrically connected to a belt-shaped positive electrode terminal 7. A tip of the belt-shaped positive electrode terminal 7 is positioned on the opposite side to the negative electrode terminal 6 and is drawn outward from the container member 2.

The secondary battery according to the second embodiment includes the electrode according to the first embodiment. For this reason, the secondary battery according to the second embodiment has excellent cycle life properties and is capable of suppressing an increase in electrical resistance.

### Third Embodiment

According to the third embodiment, a battery module is provided. The battery module according to the third embodiment is equipped with a plurality of the secondary batteries according to the second embodiment.

In the battery module according to the embodiment, individual unit cells may be electrically connected in series or in parallel, or may be arranged in combination of series connection and parallel connection.

Next, an example of the battery module according to the embodiment will be described with reference to the drawings.

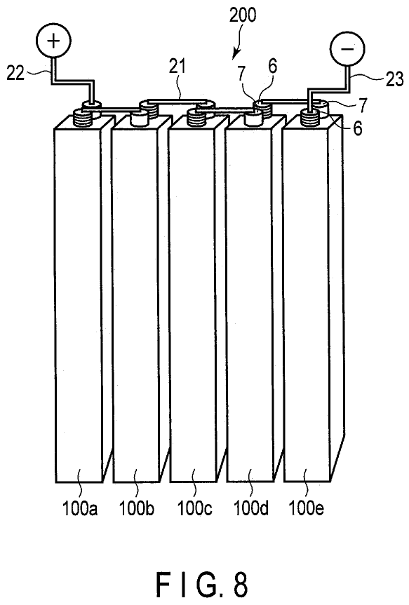

FIG. 8 is a perspective view schematically showing an example of the battery module according to the embodiment. The battery module 200 shown in FIG. 8 includes five unit cells 100a to 100e, four bus bars 21, a positive electrode-side lead 22, and a negative electrode-side lead 23. Each of the five unit cells 100a to 100e is the secondary battery according to the second embodiment.

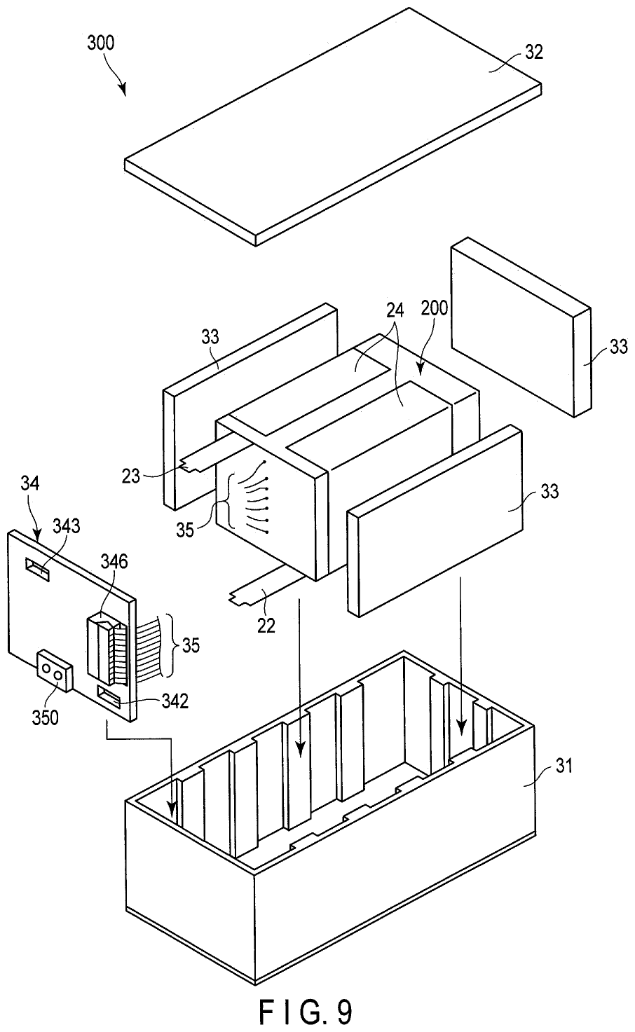

The busbar 21 connects a negative electrode terminal 6 of a single unit cell 100a to a positive electrode terminal 7 of an adjacently positioned unit cell 100b. In this way, the five unit cells 100a to 100e are connected in series by the four bus bars 21. That is, the battery module 200 shown in FIG. 9 is a battery module of five in-series connection. Although an example is not illustrated, in a battery module containing a plurality of unit cells electrically connected in parallel, the plurality of unit cells may be electrically connected by connecting the plurality of negative electrode terminals to each other with busbars and also connecting the plurality of positive electrode terminals to each other with busbars, for example.

The positive electrode terminal 7 of at least one battery among the five unit cells 100a to 100e is electrically connected to a positive electrode lead 22 for external connection. Also, the negative electrode terminal 6 of at least one battery among the five unit cells 100a to 100e is electrically connected to a negative electrode lead 23 for external connection.

The battery module according to the third embodiment includes secondary batteries according to the second embodiment. Consequently, the battery module according to the third embodiment has excellent cycle life properties and is capable of suppressing an increase in electrical resistance.

### Fourth Embodiment

According to the fourth embodiment, a battery pack is provided. The battery pack includes the battery module according to the third embodiment. The battery pack may also be equipped with a single secondary battery according to the second embodiment instead of the battery module according to the third embodiment.

The battery pack according to the embodiment may further include a protective circuit. The protective circuit has a function to control charging and discharging of the secondary battery. Alternatively, a circuit included in equipment where the battery pack serves as a power source (for example, electronic devices, vehicles, and the like) may be used as the protective circuit for the battery pack.

Moreover, the battery pack according to the embodiment may further include an external power distribution terminal. The external power distribution terminal is configured to externally output current from the secondary battery, and to input external current into the secondary battery. In other words, when the battery pack is used as a power source, the current is provided out via the external power distribution terminal. When the battery pack is charged, the charging current (including regenerative energy of a motive force of vehicles such as automobiles) is provided to the battery pack via the external power distribution terminal.

Next, an example of a battery pack according to the embodiment will be described with reference to the drawings.

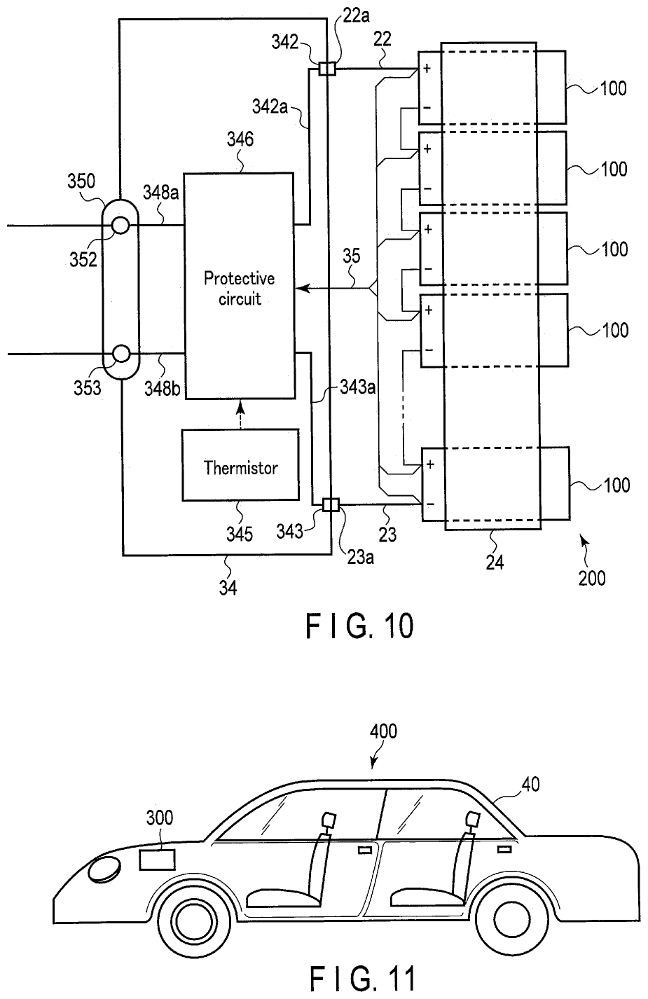

FIG. 9 is an exploded perspective view schematically showing an example of the battery pack according to the embodiment. FIG. 10 is a block diagram showing an example of an electric circuit of the battery pack shown in FIG. 9.

A battery pack 300 shown in FIGS. 9 and 10 includes a housing container 31, a lid 32, protective sheets 33, a battery module 200, a printed wiring board 34, wires 35, and an insulating plate (not shown).

A housing container 31 shown in FIG. 9 is a bottomed-square-shaped container having a rectangular bottom surface. The housing container 31 is configured to house protective sheet 33, a battery module 200, a printed wiring board 34, and wires 35. A lid 32 has a rectangular shape. The lid 32 covers the housing container 31 to house the battery module 200 and the like. Although not shown, opening(s) or connection terminal(s) for connecting to external device(s) and the like are provided on the housing container 31 and lid 32.

The battery module 200 includes plural unit cells 100, a positive electrode-side lead 22, a negative electrode-side lead 23, and an adhesive tape 24.

At least one in the plurality of unit cells 100 is a secondary battery according to the second embodiment. Each unit cell 100 in the plurality of unit cells 100 is electrically connected in series, as shown in FIG. 10. The plurality of unit cells 100 may alternatively be electrically connected in parallel, or connected in a combination of in-series connection and in-parallel connection. If the plurality of unit cells 100 is connected in parallel, the battery capacity increases as compared to a case where they are connected in series.

The adhesive tape 24 fastens the plural unit cells 100. The plural unit cells 100 may be fixed using a heat-shrinkable tape in place of the adhesive tape 24. In this case, the protective sheets 33 are arranged on both side surfaces of the battery module 200, and the heat-shrinkable tape is wound around the battery module 200 and protective sheets 33. After that, the heat-shrinkable tape is shrunk by heating to bundle the plural unit cells 100.

One terminal of a positive electrode lead 22 is connected to a battery module 200. One terminal of the positive electrode lead 22 is electrically connected to the positive electrode of one or more unit cells 100. One terminal of a negative electrode lead 23 is connected to the battery module 200. One terminal of the negative electrode lead 23 is electrically connected to the negative electrode of one or more unit cells 100.

The printed wiring board 34 is arranged on the inner surface of the housing container 31 along the short side direction. The printed wiring board 34 includes a positive electrode connector 342, a negative electrode connector 343, a thermistor 345, a protective circuit 346, wirings 342a and 343a, an external power distribution terminal 350, a plus-side wire (positive-side wire) 348a, and a minus-side wire (negative-side wire) 348b. One principal surface of the printed wiring board 34 faces one side surface of the battery module 200. An insulating plate (not shown) is disposed in between the printed wiring board 34 and the battery module 200.

The other terminal 22a of the positive electrode lead 22 is electrically connected to a positive electrode connector 342. The other terminal 23a of the negative electrode lead 23 is electrically connected to a negative electrode connector 343.

The thermistor 345 is fixed to one principal surface of the printed wiring board 34. The thermistor 345 detects the temperature of each unit cell 100 and transmits detection signals to the protective circuit 346.

The external power distribution terminal 350 is fixed to the other principal surface of the printed wiring board 34. The external power distribution terminal 350 is electrically connected to device(s) that exists outside the battery pack 300. The external power distribution terminal 350 includes a positive side terminal 352 and a negative side terminal 353.

The protective circuit 346 is fixed to the other principal surface of the printed wiring board 34. The protective circuit 346 is connected to the positive side terminal 352 via the plus-side wire 348a. The protective circuit 346 is connected to the negative side terminal 353 via the minus-side wire 348b. In addition, the protective circuit 346 is electrically connected to the positive electrode connector 342 via the wiring 342a. The protective circuit 346 is electrically connected to the negative electrode connector 343 via the wiring 343a. Furthermore, the protective circuit 346 is electrically connected to each unit cell 100 in the plurality of unit cells 100 via the wires 35.

The protective sheets 33 are arranged on both inner surfaces of the housing container 31 along the long side direction and on one inner surface of the housing container 31 along the short side direction facing the printed wiring board 34 through the battery module 200. The protective sheet 33 is made of, for example, resin or rubber.

The protective circuit 346 controls charging and discharging of the plurality of unit cells 100. The protective circuit 346 is also configured to cut off electric connection between the protective circuit 346 and the external power distribution terminal 350 (the positive side terminal 352 and the negative side terminal 353) to the external devices, based on detection signals transmitted from the thermistor 345 or detection signals transmitted from each unit cell 100 or the battery module 200.

An example of the detection signal transmitted from the thermistor 345 is a signal indicating that the temperature of the unit cell(s) 100 is detected to be a predetermined temperature or more. An example of the detection signal transmitted from each unit cell 100 or the battery module 200 is a signal indicating detection of over-charge, over-discharge, and overcurrent of the unit cell(s) 100. When detecting over-charge or the like for each of the unit cells 100, the battery voltage may be detected, or a positive electrode potential or negative electrode potential may be detected. In the latter case, a lithium electrode to be used as a reference electrode may be inserted into each unit cell 100.

Note, that as the protective circuit 346, a circuit included in a device (for example, an electronic device or an automobile) that uses the battery pack 300 as a power source may be used.

As described above, the battery pack 300 includes the external power distribution terminal 350. Hence, the battery pack 300 can output current from the battery module 200 to an external device and input current from an external device to the battery module 200 via the external power distribution terminal 350. In other words, when using the battery pack 300 as a power source, the current from the battery module 200 is supplied to an external device via the external power distribution terminal 350. When charging the battery pack 300, a charge current from an external device is supplied to the battery pack 300 via the external power distribution terminal 350. If the battery pack 300 is used as an onboard battery, the regenerative energy of the motive force of a vehicle can be used as the charge current from the external device.

Note that the battery pack 300 may include a plurality of battery modules 200. In this case, the plurality of battery modules 200 may be connected in series, in parallel, or connected in a combination of in-series connection and in-parallel connection. The printed wiring board 34 and the wires 35 may be omitted. In this case, the positive electrode lead 22 and the negative electrode lead 23 may be used as the positive side terminal and the negative side terminal of the external power distribution terminal, respectively.

Such a battery pack is used for, for example, an application required to have the excellent cycle performance when a large current is taken out. More specifically, the battery pack is used as, for example, a power source for electronic devices, a stationary battery, or an onboard battery for various kinds of vehicles. An example of the electronic device is a digital camera. The battery pack is particularly favorably used as an onboard battery.

The battery pack according to the fourth embodiment includes the secondary battery according to the second embodiment or the battery module according to the third embodiment. Consequently, according to the fourth embodiment, it is possible to provide a battery pack provided with a secondary battery or a battery module having excellent cycle life properties and capable of suppressing an increase in electrical resistance.

### Fifth Embodiment

According to the fifth embodiment, a vehicle is provided. The vehicle includes the battery pack according to the fourth embodiment.

In a vehicle according to the fifth embodiment, the battery pack is configured, for example, to recover regenerative energy from motive force of the vehicle. The vehicle may include a mechanism configured to convert kinetic energy of the vehicle into regenerative energy.

Examples of the vehicle according to the fifth embodiment include two- to four-wheeled hybrid electric automobiles, two- to four-wheeled electric automobiles, electric assist bicycles, and railway cars.

In the vehicle according to the fifth embodiment, the installing position of the battery pack is not particularly limited. For example, the battery pack may be installed in the engine compartment of the vehicle, in rear parts of the vehicle, or under seats.

A plurality of battery packs is loaded on the vehicle according to the fifth embodiment. In this case, the batteries included in each of the battery packs may be electrically connected to each other in series, in parallel, or in a combination of in-series connection and in-parallel connection. For example, in the case where each battery pack includes a battery module, the battery modules may be electrically connected to each other in series, in parallel, or in a combination of in-series connection and in-parallel connection. Alternatively, in the case where each battery pack includes a single battery, each of the batteries may be electrically connected to each other in series, in parallel, or in a combination of in-series connection and in-parallel connection.

Next, one example of the vehicle according to the fifth embodiment will be described with reference to the drawings.

FIG. 11 is a partially transparent diagram schematically illustrating one example of a vehicle according to the embodiment.

A vehicle 400 illustrated in FIG. 11 includes a vehicle body 40 and a battery pack 300 according to the embodiment. In the example illustrated in FIG. 11, the vehicle 400 is a four-wheeled automobile.

A plurality of the battery packs 300 may be loaded on the vehicle 400. In this case, the batteries included in the battery packs 300 (for example, unit cell or battery modules) may be connected in series, connected in parallel, or connected in a combination of in-series connection and in-parallel connection.

In FIG. 11, the battery pack 300 is installed in an engine compartment located at the front of the vehicle body 40. As described above, the battery pack 300 may be installed in rear sections of the vehicle body 40, or under a seat. The battery pack 300 may be used as a power source of the vehicle 400. In addition, the battery pack 300 can recover regenerative energy of a motive force of the vehicle 400.

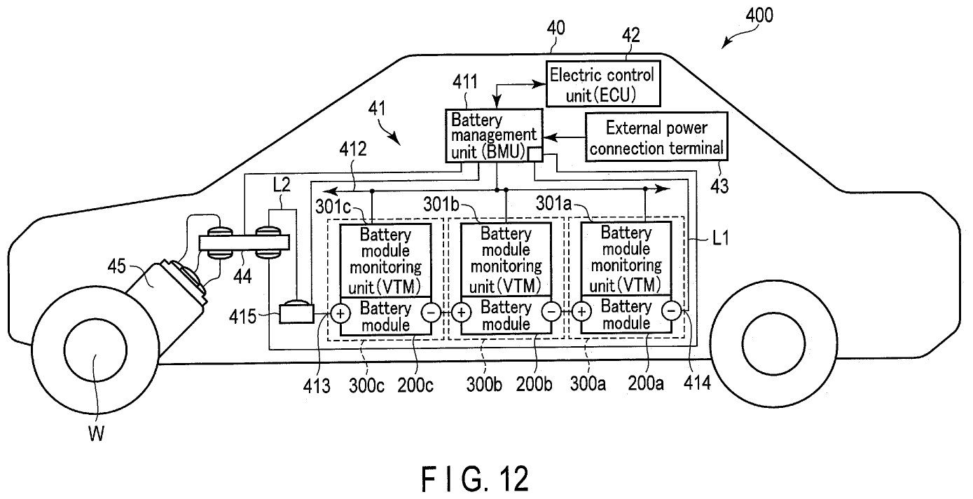

Next, an embodiment of the vehicle according to the fifth embodiment will be described with reference to FIG. 12.

FIG. 12 is a diagram schematically illustrating one example of a control system related to an electrical system in the vehicle according to the fifth embodiment. The vehicle 400 illustrated in FIG. 12 is an electric automobile.

The vehicle 400, shown in FIG. 12, includes a vehicle body 40, a vehicle power source 41, a vehicle ECU (electric control unit) 42, which is a master controller of the vehicle power source 41, an external terminal (an external power connection terminal) 43, an inverter 44, and a drive motor 45.

The vehicle 400 includes the vehicle power source 41, for example, in the engine compartment, in the rear sections of the automobile body, or under a seat. In FIG. 12, the position of the vehicle power source 41 installed in the vehicle 400 is schematically shown.

The vehicle power source 41 includes plural (for example, three) battery packs 300a, 300b and 300c, a battery management unit (BMU) 411, and a communication bus 412.

A battery pack 300a is provided with a battery module 200a and a battery module monitoring apparatus 301a (for example, voltage temperature monitoring (VTM)). A battery pack 300b is provided with a battery module 200b and a battery module monitoring apparatus 301b. A battery pack 300c is provided with a battery module 200c and a battery module monitoring apparatus 301c. The battery packs 300a to 300c are battery packs similar to the battery pack 300 described earlier, and the battery modules 200a to 200c are battery modules similar to the battery module 200 described earlier. The battery modules 200a to 200c are electrically connected in series. The battery packs 300a, 300b, and 300c are removable independently of each other, and each can be replaced with a different battery pack 300.

Each of the battery modules 200a to 200c includes plural battery cells connected in series. At least one of the plural battery cells is the secondary battery according to the second embodiment. The battery modules 200a to 200c each perform charging and discharging via a positive electrode terminal 413 and a negative electrode terminal 414.

A battery management apparatus 411 communicates with the battery module monitoring apparatus 301a to 301c, and collects information related to the voltage, temperature, and the like for each of the unit cells 100 included in the battery modules 200a to 200c included in the vehicle power source 41. With this arrangement, the battery management apparatus 411 collects information related to the maintenance of the vehicle power source 41.

The battery management apparatus 411 and the battery module monitoring apparatus 301a to 301c are connected via a communication bus 412. In the communication bus 412, a set of communication wires are shared with a plurality of nodes (the battery management apparatus 411 and one or more of the battery module monitoring apparatus 301a to 301c). The communication bus 412 is a communication bus, for example, configured in accordance with the controller area network (CAN) standard.

The battery module monitoring units 301a to 301c measure a voltage and a temperature of each battery cell in the battery modules 200a to 200c based on commands from the battery management unit 411. It is possible, however, to measure the temperatures only at several points per battery module, and the temperatures of all of the battery cells need not be measured.

The vehicle power source 41 can also have an electromagnetic contactor (for example, a switch apparatus 415 illustrated in FIG. 12) that switches the presence or absence of an electrical connection between a positive electrode terminal 413 and a negative electrode terminal 414. The switch apparatus 415 includes a pre-charge switch (not illustrated) that turns on when the battery modules 200a to 200c are charged, and a main switch (not illustrated) that turns on when the output from the battery modules 200a to 200c is supplied to the load. Each of the pre-charge switch and the main switch is provided with a relay circuit (not illustrated) that switches on or off according to a signal supplied to a coil disposed near a switching element. The electromagnetic contactor such as the switch apparatus 415 is controlled according to of control signals from the battery management apparatus 411 or the vehicle ECU 42 that controls the entire operation of the vehicle 400.

The inverter 44 converts an inputted direct current voltage to a three-phase alternate current (AC) high voltage for driving a motor. Three-phase output terminal(s) of the inverter 44 is (are) connected to each three-phase input terminal of the drive motor 45. The inverter 44 is controlled based on control signals from the battery management apparatus 411, or the vehicle ECU 42 which controls the entire operation of the vehicle. By controlling the inverter 44, the output voltage from the inverter 44 is adjusted.

The drive motor 45 is rotated by electric power supplied from the inverter 44. The driving force produced by the rotation of the drive motor 45 is transmitted to an axle (or axles) and drive wheels W via a differential gear unit for example.

The vehicle 400 also includes a regenerative brake mechanism (regenerator), though not shown. The regenerative brake mechanism rotates the drive motor 45 when the vehicle 400 is braked, and converts kinetic energy into regenerative energy, as electric energy. The regenerative energy, recovered in the regenerative brake mechanism, is inputted into the inverter 44 and converted to direct current. The converted direct current is inputted into the vehicle power source 41.

One terminal of a connection line L1 is connected to the negative electrode terminal 414 of the vehicle power source 41. The other terminal of the connection line L1 is connected to a negative electrode input terminal 417 of the inverter 44. On the connection line L1, a current detector (current detection circuit) 416 is provided inside the battery management apparatus 411 between the negative electrode terminal 414 and the negative electrode input terminal 417.

One terminal of a connection line L2 is connected to the positive electrode terminal 413 of the vehicle power source 41. The other terminal of the connection line L2 is connected to a positive electrode input terminal 418 of the inverter 44. On the connection line L2, the switch apparatus 415 is provided between the positive electrode terminal 413 and the positive electrode input terminal 418.

The external terminal 43 is connected to the battery management apparatus 411. The external terminal 43 can be connected to, for example, an external power source.

The vehicle ECU 42 cooperatively controls the vehicle power source 41, the switch apparatus 415, the inverter 44, and the like together with other management apparatus and control apparatus, including the battery management apparatus 411, in response to operation input from a driver or the like. By the cooperative control by the vehicle ECU 42 and the like, the output of electric power from the vehicle power source 41, the charging of the vehicle power source 41, and the like are controlled, and the vehicle 400 is managed as a whole. Data related to the maintenance of the vehicle power source 41, such as the remaining capacity of the vehicle power source 41, is transferred between the battery management apparatus 411 and the vehicle ECU 42 by a communication line.

The vehicle according to the fifth embodiment includes the battery pack according to the fourth embodiment. Consequently, according to the fifth embodiment, it is possible to provide a vehicle equipped with battery packs having excellent cycle life properties and capable of suppressing an increase in electrical resistance.

### EXAMPLES

Although Examples will be described hereinafter, the embodiments are not limited to Examples to be described hereinafter.

### Example 1

<Production of Intermediate Layer (Undercoat Layer)>

A slurry for forming the undercoat layer was prepared by dispersing a quantity of 30% by weight of carbon black having an average primary particle size of 10 nm as the material having electrical conductivity in an N-methyl-2-pyrrolidone (NMP) solution containing 0.5% by weight of PVDF as the binder. A gravure roll having grooves formed in a lattice was used to apply (transfer) the slurry onto one face of an aluminum alloy foil (99% pure) having a thickness of 15 μm. The width of the grooves in the gravure roll was 0.0001 mm, the spacing of the grooves was 0.0001 mm, and the depth of the grooves was 0.001 mm. The shapes of the plurality of openings formed by the application of the slurry were all square (substantially square). By drying the slurry, a laminate provided with an undercoat layer on a current collector was obtained.

<Production of Positive Electrode>

A slurry for forming the active material-containing layer was prepared by blending 90% by weight of LiNi_{0.5}Co_{0.2}Mn_{0.3}O₂ composite oxide having an average particle size of primary particles of 0.002 mm as the positive electrode active material, 5% by weight of graphite powder as the conductive agent, and 5% by weight of PVDF as the binder, and dispersing the blend in an N-methyl-2-pyrrolidone (NMP) solvent. Each of the above blending quantities is a mass with respect to the mass of the positive electrode active material-containing layer. The prepared slurry was applied to the face having the undercoat layer of the laminate produced earlier and then dried to obtain a pre-press positive electrode. The pre-press positive electrode was pressed to produce a positive electrode having a positive electrode active material-containing layer thickness of 40 μm.

<SEM Observation and Elemental Analysis by EDX>

Following the method described in the first embodiment, SEM-EDX observation was performed on the produced positive electrode, and the total area S_{B} of the openings with respect to the unit area S_{A}, the opening ratio S, and the per-opening area S1 in the undercoat layer were measured. As a result, the unit area S_{A} in the undercoat layer was 1.44 mm², the total area S_{B} of the openings was 0.36 mm², and the per-opening area S1 was 0.01 mm². Therefore, the opening ratio S (the ratio S_{B}/S_{A}) was 0.25. Also, because the average primary particle size of the positive electrode active material particles was 0.002 mm, the ratio S/r was 125.

<Production of Negative Electrode>

Li₄Ti₅O₁₂ particles having an average primary particle size of 0.0006 mm and a specific surface area of 10 m²/g were prepared as the negative electrode active material particles, graphite powder having an average particle size of 6 μm was prepared as the conductive agent, and PVDF was prepared as the binder. The negative electrode active material particles, the conductive agent, and the binder were blended in proportions of 94% by weight, 4% by weight, and 2% by weight with respect to the entire negative electrode, respectively, and dispersed in an NMP solvent. A ball mill was used to stir the dispersion under the conditions of a rotation rate of 1000 rpm and a stirring time of 2 hours to prepare a slurry. The obtained slurry was applied to one face of an aluminum alloy foil (99.3% pure) having a thickness of 15 μm, and by drying the coated film, a laminate containing a current collector and an active material-containing layer was obtained. The laminate was pressed to produce a negative electrode having a negative electrode active material-containing layer thickness of 59 μm and an electrode density of 2.2 g/cm³. The negative electrode did not have an undercoat layer.

<Preparation of Nonaqueous Electrolyte>

Propylene carbonate (PC) and diethyl carbonate (DEC) were mixed by the volume ratio of 1:2 to prepare a mixed solvent. Then, LiPF₆ was dissolved in this mixed solvent at the concentration of 1 M to prepare a nonaqueous electrolyte.

<Production of Secondary Battery>

The positive electrode obtained earlier, 20 μm-thick nonwoven fabric as separator, and negative electrode were stacked in layers so as to have the active material-containing layers of the positive electrode and of the negative electrode face each other across the separator. Thus, a laminate was obtained. The obtained laminate was wound in a roll so as to have the negative electrode located on the outermost side. Thus, an electrode group was obtained. The electrode group was subjected to hot press at 90° C. to produce a flat electrode group. The obtained electrode group was placed in a thin metallic can having the thickness of 0.25 mm and made of stainless steel. This metallic can had a valve that allows for leakage of gas at the internal pressure of 2 atm or grater. An electrolyte was injected into the metallic can to produce a secondary battery.

<Evaluation of Rate of Resistance Increase and Cycle Life Properties>

The alternating-current impedance of the produced secondary battery was measured for a state of charge (SOC) of 50% in a 25° C. environment. The point of intersection with the x-axis was taken to be the AC resistance, and the sum of the charge transfer resistance computed from the obtained arc and the above AC resistance was taken to be the DC resistance. Also, the battery was subjected to cycle testing in a 25° C. environment. In the charging and discharging, first, the battery was charged at 1 C to 3.0 V in a 25° C. environment, and then discharged at 1 C to 1.7 V. This was treated as a single charge-and-discharge cycle, and the initial discharge capacity was measured. The above charge-and-discharge cycle was repeated 1000 times, and the discharge capacity after 1000 cycles was measured. The capacity retention from the discharge capacity after 1000 cycles with respect to the initial discharge capacity was computed. The capacity retention serves as an indicator of the cycle life properties. Additionally, the alternating-current impedance of the battery after 1000 cycles was measured similarly to the above. Each ratio of resistance change after 1000 cycles with respect to each resistance at 25° C. measured initially (resistance after 1000 cycles/initial resistance×100) was computed.

The results of the above are summarized in Tables 1 and 2 below. Tables 1 and 2 also indicate the results of Examples 2 to 32 described later.

### Examples 2 to 7

The secondary batteries according to Examples 2 to 7 were produced according to a method similar to Example 1, except that the per-opening area S1, the total area S_{B} of the openings, the opening ratio S, the ratio S/r, and the ratio S1/r were varied as illustrated in Table 1.

### Examples 8 to 15

The secondary batteries according to Examples 8 to 15 were produced according to a method similar to Example 1, except that the total area S_{B} of the openings, the opening ratio S, and the ratio S/r were varied as illustrated in Table 1.

### Examples 16 to 19

The secondary batteries according to Examples 16 to 19 were produced according to a method similar to Example 1, except that the shapes of the openings was varied as illustrated in Table 1.

### Examples 20 to 25

The secondary batteries according to Examples 20 to 25 were produced according to a method similar to Example 1, except that the particles illustrated in Table 2 were used as the positive electrode active material particles.

### Examples 26 to 31

The secondary batteries according to Examples 26 to 31 were produced according to a method similar to Example 1, except that the materials illustrated in Table 1 were used as the material having electrical conductivity contained in the undercoat layer. Note that in each of Examples 26 to 31, the weight of the material having electrical conductivity occupying the undercoat layer was the same as Example 1. In Example 28, the weight ratio of carbon black and graphite was set to 50:50. In Example 29, the weight ratio of carbon black and carbon nanotubes was set to 99:1. In Example 30, the weight ratio of graphite and carbon nanotubes was set to 99:1. In Example 31, the weight ratio of graphite, carbon black, and carbon nanotubes was set to 49.5:49.5:1.

### Example 32

<Production of Positive Electrode>

A slurry for forming the active material-containing layer was prepared by blending 90% by weight of LiNi_{0.5}Co_{0.2}Mn_{0.3}O₂ composite oxide having an average particle size of primary particles of 0.002 mm as the positive electrode active material, 5% by weight of graphite powder as the conductive agent, and 5% by weight of PVDF as the binder, and dispersing the blend in an N-methyl-2-pyrrolidone (NMP) solvent. Each of the above blending quantities is a weight with respect to the weight of the positive electrode active material-containing layer. The prepared slurry was applied to one face of an aluminum alloy foil (99% pure) having a thickness of 15 μm and dried to obtain a laminate. The laminate was pressed to produce a positive electrode having a positive electrode active material-containing layer thickness of 40 μm on one side. The positive electrode did not have an undercoat layer.

<Production of Negative Electrode>

First, a laminate provided with an undercoat layer was produced according to a method similar to the one described in Example 1.

Next, Nb₂TiO₇ particles having an average primary particle size of 0.001 mm were prepared as the negative electrode active material particles, graphite powder having an average particle size of 6 μm was prepared as the conductive agent, and PVDF was prepared as the binder. The negative electrode active material particles, the conductive agent, and the binder were blended in proportions of 94% by weight, 4% by weight, and 2% by weight with respect to the entire negative electrode, respectively, and dispersed in an NMP solvent. A ball mill was used to stir the dispersion under the conditions of a rotation rate of 1000 rpm and a stirring time of 2 hours to prepare a slurry. The obtained slurry was applied to the face having the undercoat layer of the laminate produced in advance and then dried to obtain a pre-press negative electrode. The pre-press negative electrode was pressed to produce a negative electrode having a negative electrode active material-containing layer thickness of 59 μm.

<SEM Observation and Elemental Analysis by EDX>

Following the method described in the first embodiment, SEM-EDX observation was performed on the produced negative electrode, and the total area S_{B} of the openings with respect to the unit area S_{A}, the opening ratio S, and the per-opening area S1 in the undercoat layer were measured. As a result, the unit area S_{A} in the undercoat layer was 1.44 mm², the total area S_{B} of the openings was 0.36 mm², and the per-opening area S1 was 0.01 mm². Therefore, the opening ratio S (the ratio S_{B}/S_{A}) was 0.25. Also, because the average primary particle size of the negative electrode active material particles was 0.001 mm, the ratio S/r was 250.

<Preparation of Nonaqueous Electrolyte>

Propylene carbonate (PC) and diethyl carbonate (DEC) were mixed by the volume ratio of 1:2 to prepare a mixed solvent. Then, LiPF₆ was dissolved in this mixed solvent at the concentration of 1 M to prepare a nonaqueous electrolyte.

<Production of Secondary Battery>

The positive electrode obtained earlier, 20 μm-thick nonwoven fabric as separator, and negative electrode were stacked in layers so as to have the active material-containing layers of the positive electrode and of the negative electrode face each other across the separator. Thus, a laminate was obtained. The obtained laminate was wound in a roll so as to have the negative electrode located on the outermost side. Thus, an electrode group was obtained. The electrode group was subjected to hot press at 90° C. to produce a flat electrode group. The obtained electrode group was placed in a thin metallic can having the thickness of 0.25 mm and made of stainless steel. This metallic can had a valve that allows for leakage of gas at the internal pressure of 2 atm or grater. An electrolyte was injected into the metallic can to produce a secondary battery.

<Evaluation of Rate of Resistance Increase and Cycle Life Properties>

The rate of resistance increase and the cycle life properties of the secondary battery according to Example 32 were evaluated according to a method similar to the one described in Example 1.

The results of the above are summarized in Tables 3 and 4 below. Tables 3 and 4 also indicate the results of Examples 33 to 55 as well as Comparative Examples 1 to 6 described later.

### Examples 33 to 38

The secondary batteries according to Examples 33 to 38 were produced according to a method similar to Example 32, except that the per-opening area S1, the total area S_{B} of the openings, the opening ratio S, the ratio S/r, and the ratio S1/r were varied as illustrated in Table 3.

### Examples 39 to 46

The secondary batteries according to Examples 39 to 46 were produced according to a method similar to Example 32, except that the total area S_{B} of the openings, the opening ratio S, and the ratio S r were varied as illustrated in Table 3.

### Examples 47 to 50

The secondary batteries according to Examples 47 to 50 were produced according to a method similar to Example 32, except that the shapes of the openings was varied as illustrated in Table 3.

### Examples 51 to 53

The secondary batteries according to Examples 51 to 53 were produced according to a method similar to Example 32, except that the particles illustrated in Table 4 were used as the negative electrode active material particles.

(Example 54) A secondary battery was produced according to a method similar to Example 1, except that a negative electrode provided with an undercoat layer was produced according to a method similar to the one described in Example 51. In other words, an undercoat layer was provided on both the positive electrode and the negative electrode provided in the secondary battery according to Example 54. In the “Per-opening area S1”, “Total area S2 of openings”, “Opening ratio S”, “Opening shape”, “Ratio S/r”, and “Ratio S1/r” columns of Table 3, various parameters related to the undercoat layer formed on the negative electrode are illustrated.

### Example 55

A secondary battery was produced according to a method similar to Example 1, except that a negative electrode provided with an undercoat layer was produced according to a method similar to the one described in Example 32. In other words, an undercoat layer was provided on both the positive electrode and the negative electrode provided in the secondary battery according to Example 55. In the “Per-opening area S1”, “Total area S_{B} of openings”, “Opening ratio S”, “Opening shape”, “Ratio S/r”, and “Ratio S1/r” columns of Table 3, various parameters related to the undercoat layer formed on the negative electrode are illustrated.

### Comparative Example 1

A secondary battery was produced according to a method similar to the one described in Example 1, except that a positive electrode not provided with an undercoat layer was produced according to a method similar to the one described in Example 32. In other words, an undercoat layer was provided on neither the positive electrode nor the negative electrode provided in the secondary battery according to Comparative Example 1. In Table 3, for Comparative Example 1, “bare” is listed in the material having electrical conductivity field.

### Comparative Example 2

A secondary battery was produced according to a method similar to Example 1, except that a positive electrode and a negative electrode were produced according to the following procedure.

<Production of Positive Electrode>

A slurry for forming the active material-containing layer was prepared by blending 90% by weight of LiNi_{0.5}Co_{0.2}Mn_{0.3}O₂ composite oxide having an average particle size of primary particles of 0.002 mm as the positive electrode active material, 5% by weight of graphite powder as the conductive agent, and 5% by weight of PVDF as the binder, and dispersing the blend in an N-methyl-2-pyrrolidone (NMP) solvent. Each of the above blending quantities is a weight with respect to the weight of the positive electrode active material-containing layer.

As the current collector, aluminum foil (edged foil) having a thickness of 15 μm and on the surface of which a plurality of edges (cracks) extending in the thickness direction existed was prepared.

The slurry prepared earlier was applied to the edged face of the above aluminum foil and dried to obtain a laminate. The laminate was then pressed to produce the positive electrode. The positive electrode did not have an undercoat layer.

<Production of Negative Electrode>

Li₄Ti₅O₁₂ particles having an average primary particle size of 0.6 μm and a specific surface area of 10 m²/g were prepared as the negative electrode active material particles, graphite powder having an average particle size of 6 μm was prepared as the conductive agent, and PVDF was prepared as the binder. The negative electrode active material particles, the conductive agent, and the binder were blended in proportions of 94% by weight, 4% by weight, and 2% by weight with respect to the entire negative electrode, respectively, and dispersed in an NMP solvent. A ball mill was used to stir the dispersion under the conditions of a rotation rate of 1000 rpm and a stirring time of 2 hours to prepare a slurry.

As the current collector, aluminum foil (edged foil) having a thickness of 15 μm and on the surface of which a plurality of edges (cracks) extending in the thickness direction existed was prepared.

The slurry prepared earlier was applied to the edged face of the above aluminum foil and dried to obtain a laminate. The laminate was then pressed to produce the negative electrode. The negative electrode did not have an undercoat layer.

In Table 3, for Comparative Example 2, “edged” is listed in the material having electrical conductivity field.

### Comparative Example 3

A secondary battery was produced according to a method similar to Example 1, except that the opening ratio S was set to 0.0003 and the ratio S/r was changed to 0.15, by setting the total area S_{B} of the openings to 0.0004 mm².

### Comparative Example 4

A secondary battery was produced according to a method similar to Example 1, except that the opening ratio S was set to 0.98 and the ratio S/r was changed to 1960, by setting the total area S_{B} of the openings to 1.41 mm².

### Comparative Example 5

The secondary battery according to Comparative Example 5 was produced according to a method similar to Example 1, except that by using a roll without grooves as the gravure roll, openings were not provided in the undercoat layer included in the positive electrode.

### Comparative Example 6

First, a solidly-applied undercoat layer lacking openings was produced on a positive electrode current collector according to a method similar to Comparative Example 5. After that, on this undercoat layer, an additional undercoat layer was produced by using the same gravure roll as the gravure roll used in Example 1. In other words, the undercoat layer produced in Comparative Example 6 did not have openings, but was an undercoat layer having an uneven surface similar to the undercoat layer formed in Example 1.

The secondary battery according to Comparative Example 6 was produced according to a method similar to Example 1, except that the undercoat layer included in the positive electrode was produced as above.

TABLE 1

| | Material having electrical | Electrode having | Per-opening | Total area S_{B} | Opening | | | |
|---|---|---|---|---|---|---|---|---|
| | conductivity contained | undercoat | area S1 | of openings | ratio | Opening | Ratio | Ratio |
| | in undercoat layer | layer | (mm²) | (mm²) | S | shapes | S/r | S1/r |
| Example 1 | Carbon black | Positive electrode | 0.01 | 0.36 | 0.25 | Quadrangular | 125 | 5 |
| Example 2 | Carbon black | Positive electrode | 0.02 | 0.49 | 0.34 | Quadrangular | 172 | 10 |
| Example 3 | Carbon black | Positive electrode | 0.05 | 0.69 | 0.48 | Quadrangular | 239 | 25 |
| Example 4 | Carbon black | Positive electrode | 0.1 | 0.83 | 0.58 | Quadrangular | 289 | 50 |
| Example 5 | Carbon black | Positive electrode | 0.2 | 0.96 | 0.67 | Quadrangular | 334 | 100 |
| Example 6 | Carbon black | Positive electrode | 0.5 | 1.11 | 0.77 | Quadrangular | 384 | 250 |
| Example 7 | Carbon black | Positive electrode | 1 | 1.19 | 0.83 | Quadrangular | 413 | 500 |
| Example 8 | Carbon black | Positive electrode | 0.01 | 1.21 | 0.84 | Quadrangular | 420 | 5 |
| Example 9 | Carbon black | Positive electrode | 0.01 | 0.80 | 0.56 | Quadrangular | 280 | 5 |
| Example 10 | Carbon black | Positive electrode | 0.01 | 0.01 | 0.01 | Quadrangular | 4 | 5 |
| Example 11 | Carbon black | Positive electrode | 0.01 | 0.03 | 0.02 | Quadrangular | 10 | 5 |
| Example 12 | Carbon black | Positive electrode | 0.01 | 0.06 | 0.04 | Quadrangular | 20 | 5 |
| Example 13 | Carbon black | Positive electrode | 0.01 | 0.18 | 0.12 | Quadrangular | 62 | 5 |
| Example 14 | Carbon black | Positive electrode | 0.01 | 0.29 | 0.20 | Quadrangular | 100 | 5 |
| Example 15 | Carbon black | Positive electrode | 0.01 | 0.52 | 0.36 | Quadrangular | 180 | 5 |
| Example 16 | Carbon black | Positive electrode | 0.01 | 0.36 | 0.25 | Triangular | 125 | 5 |
| Example 17 | Carbon black | Positive electrode | 0.01 | 0.36 | 0.25 | Pentagonal | 125 | 5 |
| Example 18 | Carbon black | Positive electrode | 0.01 | 0.36 | 0.25 | Hexagonal | 125 | 5 |
| Example 19 | Carbon black | Positive electrode | 0.01 | 0.36 | 0.25 | Circular | 125 | 5 |
| Example 20 | Carbon black | Positive electrode | 0.01 | 0.36 | 0.25 | Quadrangular | 250 | 10 |
| Example 21 | Carbon black | Positive electrode | 0.01 | 0.36 | 0.25 | Quadrangular | 313 | 12.5 |
| Example 22 | Carbon black | Positive electrode | 0.01 | 0.36 | 0.25 | Quadrangular | 50 | 2 |
| Example 23 | Carbon black | Positive electrode | 0.01 | 0.36 | 0.25 | Quadrangular | 125 | 5 |
| Example 24 | Carbon black | Positive electrode | 0.01 | 0.36 | 0.25 | Quadrangular | 63 | 2.5 |
| Example 25 | Carbon black | Positive electrode | 0.01 | 0.36 | 0.25 | Quadrangular | 500 | 20 |
| Example 26 | Graphite | Positive electrode | 0.01 | 0.36 | 0.25 | Quadrangular | 125 | 5 |
| Example 27 | Carbon nanotube | Positive electrode | 0.01 | 0.36 | 0.25 | Quadrangular | 125 | 5 |
| Example 28 | Carbon black + | Positive electrode | 0.01 | 0.36 | 0.25 | Quadrangular | 125 | 5 |
| | graphite | | | | | | | |
| Example 29 | Carbon black + | Positive electrode | 0.01 | 0.36 | 0.25 | Quadrangular | 125 | 5 |
| | carbon nanotube | | | | | | | |
| Example 30 | Graphite + | Positive electrode | 0.01 | 0.36 | 0.25 | Quadrangular | 125 | 5 |
| | carbon nanotube | | | | | | | |
| Example 31 | Graphite + | Positive electrode | 0.01 | 0.36 | 0.25 | Quadrangular | 125 | 5 |
| | carbon black + | | | | | | | |
| | carbon nanotube | | | | | | | |

TABLE 2

| | Positive | Average primary | Negative | Average primary | Capacity retention | Rate of AC | Rate of DC |
|---|---|---|---|---|---|---|---|
| | electrode | particle size | electrode | particle size | of 25° C. life | resistance | resistance |
| | active | of positive | active | of negative | properties (%) | increase (%) | increase (%) |
| | material | electrode active | material | electrode active | (1000 cycles/ | (1000 cycles/ | (1000 cycles/ |
| | type | material (mm) | type | material (mm) | 1 cycle) | 1 cycle) | 1 cycle) |
| Example 1 | LiNi_{0.5}Co_{0.2}Mn_{0.3}O₂ | 0.002 | Li₄Ti₅O₁₂ | 0.0006 | 99 | 3 | 2 |
| Example 2 | LiNi_{0.5}Co_{0.2}Mn_{0.3}O₂ | 0.002 | Li₄Ti₅O₁₂ | 0.0006 | 98 | 5 | 2 |
| Example 3 | LiNi_{0.5}Co_{0.2}Mn_{0.3}O₂ | 0.002 | Li₄Ti₅O₁₂ | 0.0006 | 99 | 4 | 3 |
| Example 4 | LiNi_{0.5}Co_{0.2}Mn_{0.3}O₂ | 0.002 | Li₄Ti₅O₁₂ | 0.0006 | 99 | 3 | 2 |
| Example 5 | LiNi_{0.5}Co_{0.2}Mn_{0.3}O₂ | 0.002 | Li₄Ti₅O₁₂ | 0.0006 | 97 | 2 | 3 |
| Example 6 | LiNi_{0.5}Co_{0.2}Mn_{0.3}O₂ | 0.002 | Li₄Ti₅O₁₂ | 0.0006 | 99 | 2 | 3 |
| Example 7 | LiNi_{0.5}Co_{0.2}Mn_{0.3}O₂ | 0.002 | Li₄Ti₅O₁₂ | 0.0006 | 98 | 5 | 4 |
| Example 8 | LiNi_{0.5}Co_{0.2}Mn_{0.3}O₂ | 0.002 | Li₄Ti₅O₁₂ | 0.0006 | 99 | 4 | 3 |
| Example 9 | LiNi_{0.5}Co_{0.2}Mn_{0.3}O₂ | 0.002 | Li₄Ti₅O₁₂ | 0.0006 | 98 | 3 | 3 |
| Example 10 | LiNi_{0.5}Co_{0.2}Mn_{0.3}O₂ | 0.002 | Li₄Ti₅O₁₂ | 0.0006 | 97 | 2 | 2 |
| Example 11 | LiNi_{0.5}Co_{0.2}Mn_{0.3}O₂ | 0.002 | Li₄Ti₅O₁₂ | 0.0006 | 99 | 4 | 4 |
| Example 12 | LiNi_{0.5}Co_{0.2}Mn_{0.3}O₂ | 0.002 | Li₄Ti₅O₁₂ | 0.0006 | 99 | 2 | 3 |
| Example 13 | LiNi_{0.5}Co_{0.2}Mn_{0.3}O₂ | 0.002 | Li₄Ti₅O₁₂ | 0.0006 | 98 | 3 | 4 |
| Example 14 | LiNi_{0.5}Co_{0.2}Mn_{0.3}O₂ | 0.002 | Li₄Ti₅O₁₂ | 0.0006 | 99 | 2 | 2 |
| Example 15 | LiNi_{0.5}Co_{0.2}Mn_{0.3}O₂ | 0.002 | Li₄Ti₅O₁₂ | 0.0006 | 99 | 2 | 2 |
| Example 16 | LiNi_{0.5}Co_{0.2}Mn_{0.3}O₂ | 0.002 | Li₄Ti₅O₁₂ | 0.0006 | 97 | 5 | 3 |
| Example 17 | LiNi_{0.5}Co_{0.2}Mn_{0.3}O₂ | 0.002 | Li₄Ti₅O₁₂ | 0.0006 | 98 | 2 | 3 |
| Example 18 | LiNi_{0.5}Co_{0.2}Mn_{0.3}O₂ | 0.002 | Li₄Ti₅O₁₂ | 0.0006 | 99 | 3 | 4 |
| Example 19 | LiNi_{0.5}Co_{0.2}Mn_{0.3}O₂ | 0.002 | Li₄Ti₅O₁₂ | 0.0006 | 98 | 4 | 2 |
| Example 20 | LiNi_{0.6}Co_{0.2}Mn_{0.2}O₂ | 0.001 | Li₄Ti₅O₁₂ | 0.0006 | 93 | 8 | 9 |
| Example 21 | LiNi_{0.33}Co_{0.33}Mn_{0.33}O₂ | 0.0008 | Li₄Ti₅O₁₂ | 0.0006 | 97 | 3 | 2 |
| Example 22 | LiNi_{0.8}Co_{0.1}Mn_{0.1}O₂ | 0.005 | Li₄Ti₅O₁₂ | 0.0006 | 86 | 8 | 10 |
| Example 23 | LiMn₂O₄ | 0.002 | Li₄Ti₅O₁₂ | 0.0006 | 99 | 2 | 3 |
| Example 24 | LiCoO₂ | 0.004 | Li₄Ti₅O₁₂ | 0.0006 | 95 | 3 | 4 |
| Example 25 | LiFePO₄ | 0.0005 | Li₄Ti₅O₁₂ | 0.0006 | 99 | 2 | 3 |
| Example 26 | LiNi_{0.5}Co_{0.2}Mn_{0.3}O₂ | 0.002 | Li₄Ti₅O₁₂ | 0.0006 | 99 | 2 | 3 |
| Example 27 | LiNi_{0.5}Co_{0.2}Mn_{0.3}O₂ | 0.002 | Li₄Ti₅O₁₂ | 0.0006 | 99 | 3 | 3 |
| Example 28 | LiNi_{0.5}Co_{0.2}Mn_{0.3}O₂ | 0.002 | Li₄Ti₅O₁₂ | 0.0006 | 99 | 2 | 3 |
| Example 29 | LiNi_{0.5}Co_{0.2}Mn_{0.3}O₂ | 0.002 | Li₄Ti₅O₁₂ | 0.0006 | 99 | 3 | 4 |
| Example 30 | LiNi_{0.5}Co_{0.2}Mn_{0.3}O₂ | 0.002 | Li₄Ti₅O₁₂ | 0.0006 | 99 | 4 | 3 |
| Example 31 | LiNi_{0.5}Co_{0.2}Mn_{0.3}O₂ | 0.002 | Li₄Ti₅O₁₂ | 0.0006 | 99 | 3 | 3 |

TABLE 3

| | Material having electrical | Electrode having | Per-opening | Total area S_{B} | Opening | | | |
|---|---|---|---|---|---|---|---|---|
| | conductivity contained | undercoat | area S1 | of openings | ratio | Opening | Ratio | Ratio |
| | in undercoat layer | layer | (mm²) | (mm²) | S | shapes | S/r | S1/r |
| Example 32 | Carbon black | Negative electrode | 0.01 | 0.36 | 0.25 | Quadrangular | 250 | 10 |
| Example 33 | Carbon black | Negative electrode | 0.02 | 0.49 | 0.34 | Quadrangular | 343 | 20 |
| Example 34 | Carbon black | Negative electrode | 0.05 | 0.69 | 0.48 | Quadrangular | 477 | 50 |
| Example 35 | Carbon black | Negative electrode | 0.1 | 0.83 | 0.58 | Quadrangular | 577 | 100 |
| Example 36 | Carbon black | Negative electrode | 0.2 | 0.96 | 0.67 | Quadrangular | 668 | 200 |
| Example 37 | Carbon black | Negative electrode | 0.5 | 1.11 | 0.77 | Quadrangular | 768 | 500 |
| Example 38 | Carbon black | Negative electrode | 1 | 1.19 | 0.83 | Quadrangular | 826 | 1000 |
| Example 39 | Carbon black | Negative electrode | 0.01 | 1.21 | 0.84 | Quadrangular | 840 | 10 |
| Example 40 | Carbon black | Negative electrode | 0.01 | 0.80 | 0.56 | Quadrangular | 560 | 10 |
| Example 41 | Carbon black | Negative electrode | 0.01 | 0.01 | 0.01 | Quadrangular | 8 | 10 |
| Example 42 | Carbon black | Negative electrode | 0.01 | 0.03 | 0.02 | Quadrangular | 20 | 10 |
| Example 43 | Carbon black | Negative electrode | 0.01 | 0.06 | 0.04 | Quadrangular | 40 | 10 |
| Example 44 | Carbon black | Negative electrode | 0.01 | 0.18 | 0.12 | Quadrangular | 123 | 10 |
| Example 45 | Carbon black | Negative electrode | 0.01 | 0.29 | 0.20 | Quadrangular | 199 | 10 |
| Example 46 | Carbon black | Negative electrode | 0.01 | 0.52 | 0.36 | Quadrangular | 361 | 10 |
| Example 47 | Carbon black | Negative electrode | 0.01 | 0.36 | 0.25 | Triangular | 250 | 10 |
| Example 48 | Carbon black | Negative electrode | 0.01 | 0.36 | 0.25 | Pentagonal | 250 | 10 |
| Example 49 | Carbon black | Negative electrode | 0.01 | 0.36 | 0.25 | Hexagonal | 250 | 10 |
| Example 50 | Carbon black | Negative electrode | 0.01 | 0.36 | 0.25 | Circular | 250 | 10 |
| Example 51 | Carbon black | Negative electrode | 0.01 | 0.36 | 0.25 | Quadrangular | 417 | 16.7 |
| Example 52 | Carbon black | Negative electrode | 0.01 | 0.36 | 0.25 | Quadrangular | 500 | 20 |
| Example 53 | Carbon black | Negative electrode | 0.01 | 0.36 | 0.25 | Quadrangular | 250 | 10 |
| Example 54 | Carbon black | Positive electrode, | 0.01 | 0.36 | 0.25 | Quadrangular | 417 | 16.7 |
| | | Negative electrode | | | | | | |
| Example 55 | Carbon black | Positive electrode, | 0.01 | 0.36 | 0.25 | Quadrangular | 250 | 10 |
| | | Negative electrode | | | | | | |
| Comparative | Bare | — | — | — | — | — | — | — |
| Example 1 | | | | | | | | |
| Comparative | Edged | — | — | — | — | — | — | — |
| Example 2 | | | | | | | | |
| Comparative | Carbon black | Positive electrode | 0.01 | 0.0004 | 0.0003 | Quadrangular | 0.15 | 5 |
| Example 3 | | | | | | | | |
| Comparative | Carbon black | Positive electrode | 0.01 | 1.41 | 0.98 | Quadrangular | 1960 | 20 |
| Example 4 | | | | | | | | |
| Comparative | Carbon black | Positive electrode | 0 | 0 | — | Solid | — | — |
| Example 5 | | | | | | | | |
| Comparative | Carbon black | Positive electrode | 0 | 0 | — | Solid + uneven | — | — |
| Example 6 | | | | | | surface | | |

TABLE 4

| | Positive | Average primary | Negative | Average primary | Capacity retention | Rate of AC | Rate of DC |
|---|---|---|---|---|---|---|---|
| | electrode | particle size | electrode | particle size | of 25° C. life | resistance | resistance |
| | active | of positive | active | of negative | properties (%) | increase (%) | increase (%) |
| | material | electrode active | material | electrode active | (1000 cycles/ | (1000 cycles/ | (1000 cycles/ |
| | type | material (mm) | type | material (mm) | 1 cycle) | 1 cycle) | 1 cycle) |
| Example 32 | LiNi_{0.5}Co_{0.2}Mn_{0.3}O₂ | 0.002 | Nb₂TiO₇ | 0.001 | 97 | 2 | 5 |
| Example 33 | LiNi_{0.5}Co_{0.2}Mn_{0.3}O₂ | 0.002 | Nb₂TiO₇ | 0.001 | 96 | 4 | 8 |
| Example 34 | LiNi_{0.5}Co_{0.2}Mn_{0.3}O₂ | 0.002 | Nb₂TiO₇ | 0.001 | 94 | 5 | 9 |
| Example 35 | LiNi_{0.5}Co_{0.2}Mn_{0.3}O₂ | 0.002 | Nb₂TiO₇ | 0.001 | 93 | 8 | 8 |
| Example 36 | LiNi_{0.5}Co_{0.2}Mn_{0.3}O₂ | 0.002 | Nb₂TiO₇ | 0.001 | 94 | 7 | 11 |
| Example 37 | LiNi_{0.5}Co_{0.2}Mn_{0.3}O₂ | 0.002 | Nb₂TiO₇ | 0.001 | 93 | 8 | 10 |
| Example 38 | LiNi_{0.5}Co_{0.2}Mn_{0.3}O₂ | 0.002 | Nb₂TiO₇ | 0.001 | 93 | 10 | 13 |
| Example 39 | LiNi_{0.5}Co_{0.2}Mn_{0.3}O₂ | 0.002 | Nb₂TiO₇ | 0.001 | 92 | 4 | 14 |
| Example 40 | LiNi_{0.5}Co_{0.2}Mn_{0.3}O₂ | 0.002 | Nb₂TiO₇ | 0.001 | 91 | 3 | 11 |
| Example 41 | LiNi_{0.5}Co_{0.2}Mn_{0.3}O₂ | 0.002 | Nb₂TiO₇ | 0.001 | 92 | 2 | 9 |
| Example 42 | LiNi_{0.5}Co_{0.2}Mn_{0.3}O₂ | 0.002 | Nb₂TiO₇ | 0.001 | 94 | 4 | 8 |
| Example 43 | LiNi_{0.5}Co_{0.2}Mn_{0.3}O₂ | 0.002 | Nb₂TiO₇ | 0.001 | 94 | 2 | 8 |
| Example 44 | LiNi_{0.5}Co_{0.2}Mn_{0.3}O₂ | 0.002 | Nb₂TiO₇ | 0.001 | 95 | 3 | 7 |
| Example 45 | LiNi_{0.5}Co_{0.2}Mn_{0.3}O₂ | 0.002 | Nb₂TiO₇ | 0.001 | 98 | 3 | 6 |
| Example 46 | LiNi_{0.5}Co_{0.2}Mn_{0.3}O₂ | 0.002 | Nb₂TiO₇ | 0.001 | 96 | 3 | 8 |
| Example 47 | LiNi_{0.5}Co_{0.2}Mn_{0.3}O₂ | 0.002 | Nb₂TiO₇ | 0.001 | 97 | 3 | 6 |
| Example 48 | LiNi_{0.5}Co_{0.2}Mn_{0.3}O₂ | 0.002 | Nb₂TiO₇ | 0.001 | 98 | 4 | 7 |
| Example 49 | LiNi_{0.5}Co_{0.2}Mn_{0.3}O₂ | 0.002 | Nb₂TiO₇ | 0.001 | 99 | 4 | 6 |
| Example 50 | LiNi_{0.5}Co_{0.2}Mn_{0.3}O₂ | 0.002 | Nb₂TiO₇ | 0.001 | 98 | 4 | 5 |
| Example 51 | LiNi_{0.5}Co_{0.2}Mn_{0.3}O₂ | 0.002 | Li₄Ti₅O₁₂ | 0.0006 | 98 | 3 | 2 |
| Example 52 | LiNi_{0.5}Co_{0.2}Mn_{0.3}O₂ | 0.002 | TiO₂ | 0.0005 | 92 | 10 | 10 |
| Example 53 | LiNi_{0.5}Co_{0.2}Mn_{0.3}O₂ | 0.002 | Li₂Na_{1.8}Ti_{5.8}Nb_{0.2}O₁₄ | 0.001 | 94 | 5 | 8 |
| Example 54 | LiNi_{0.5}Co_{0.2}Mn_{0.3}O₂ | 0.002 | Li₄Ti₅O₁₂ | 0.0006 | 99 | 1 | 2 |
| Example 55 | LiNi_{0.5}Co_{0.2}Mn_{0.3}O₂ | 0.002 | Nb₂TiO₇ | 0.001 | 99 | 2 | 3 |
| Comparative | LiNi_{0.5}Co_{0.2}Mn_{0.3}O₂ | 0.002 | Li₄Ti₅O₁₂ | 0.0006 | 89 | 11 | 14 |
| Example 1 | | | | | | | |
| Comparative | LiNi_{0.5}Co_{0.2}Mn_{0.3}O₂ | 0.002 | Li₄Ti₅O₁₂ | 0.0006 | 91 | 10 | 12 |
| Example 2 | | | | | | | |
| Comparative | LiNi_{0.5}Co_{0.2}Mn_{0.3}O₂ | 0.002 | Li₄Ti₅O₁₂ | 0.0006 | 92 | 12 | 13 |
| Example 3 | | | | | | | |
| Comparative | LiNi_{0.5}Co_{0.2}Mn_{0.3}O₂ | 0.0005 | Li₄Ti₅O₁₂ | 0.0006 | 92 | 11 | 12 |
| Example 4 | | | | | | | |
| Comparative | LiNi_{0.5}Co_{0.2}Mn_{0.3}O₂ | 0.002 | Li₄Ti₅O₁₂ | 0.0006 | 85 | 11 | 12 |
| Example 5 | | | | | | | |
| Comparative | LiNi_{0.5}Co_{0.2}Mn_{0.3}O₂ | 0.002 | Li₄Ti₅O₁₂ | 0.0006 | 88 | 12 | 12 |
| Example 6 | | | | | | | |

Tables 1 to 4 demonstrate the following.

Examples 1 to 55 are examples in which the ratio S/r is within a range from 1 to 1700. These Examples 1 to 55 are demonstrated to have better capacity retention, rate of AC resistance increase, and rate of DC resistance increase compared to Comparative Examples 1 to 6. The examples having a low rate of AC resistance increase tend to be capable of suppressing peeling of the active material-containing layer, or in other words, significantly suppressing an increase in contact resistance. On the other hand, the examples having a low rate of DC resistance increase tend to be capable of significantly suppressing increases in reaction resistance and diffusion resistance.

As demonstrated in Examples 8 to 15 and Examples 39 to 46, in the case of varying the total area S_{B} of the openings, if the total area S_{B} of the openings is from 0.01 mm² to 0.52 mm², excellent cycle life properties are exhibited, and a resistance increase is successfully suppressed. This is illustrated in Examples 39 to 46 in which an undercoat layer is provided on the negative electrode.

Regarding Examples 32 to 38, it is demonstrated that in Examples 32 to 34 in which the ratio S1/r of the per-opening area S1 and the average primary particle size of the active material particles is within a range from 10 to 50, excellent cycle life properties are exhibited and a resistance increase is successfully suppressed compared to Examples 35 to 38 in which the ratio S1/r is within a range from 100 to 1000. For the same opening ratio S, a smaller per-opening area S1 means that a greater number of openings are provided in the undercoat layer. For this reason, if the per-opening area S1 is relatively small, the anchor effect of the undercoat layer is thought to be exhibited favorably.

If Comparative Examples 1 and 2 are compared against Example 1, Comparative Examples 1 and 2 that lack an undercoat layer are demonstrated to have poor cycle life properties and a high rate of both AC and DC resistance increase compared to Example 1. In Comparative Example 1 provided with a bare (lacking an undercoat layer) aluminum current collector having a smooth surface, peeling of the active material-containing layer due to repeated charge-and-discharge cycles is thought to be advanced. Also, even if an aluminum current collector having cracks on the surface is used like in Comparative Example 2, because an undercoat layer is not present, there is a possibility that the peel strength of the active material-containing layer will be insufficient.

Comparative Example 3 in which the ratio S/r is less than 1 and Comparative Example 4 in which the ratio S/r exceeds 1700 are demonstrated to have poor life cycle properties and a high rate of both AC and DC resistance increase compared to Example 1.

In the case of providing an undercoat layer lacking openings like in Comparative Examples 5 and 6, there is a tendency not only for the cycle life properties to be poor, but also for a high rate of both AC and DC resistance increase.

According at least one of the embodiments and Examples described above, an electrode is provided. The electrode includes a current collector, an intermediate layer containing a material having electrical conductivity, and an active material-containing layer containing active material particles, in this order. The intermediate layer includes at least one opening and satisfies the following formula (1).

1≤S/r≤1700 (1)

In formula (1) above, S is the ratio S_{B}/S_{A} of the total area S_{B} of the openings with respect to the unit area S_{A} in the undercoat layer, and r is the average primary particle size of the active material particles.

According to the electrode, a secondary battery having excellent cycle life properties and capable of suppressing an increase in electrical resistance can be achieved.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electrode comprising: a current collector, an intermediate layer comprising a material having electrical conductivity, and an active material-containing layer comprising active material particles, in this order,
wherein the intermediate layer comprises at least one opening and satisfies following formula (1),
1≤S/r≤1700 (1)
where S is a ratio S_{B}/S_{A} of a total area S_{B} of the at least one opening with respect to a unit area S_{A} in the intermediate layer, and r is an average primary particle size of the active material particles.

2. The electrode according to claim 1, wherein the active material particles exists in the at least one opening.

3. The electrode according to claim 1, wherein the intermediate layer further satisfies following formula (2),
0.1≤S1/r≤1×10⁸ (2)
where S1 is an area per the at least one opening, and r is an average primary particle size of the active material particles.

4. The electrode according to claim 1, wherein S is within a range from 0.001 to 0.9.

5. The electrode according to claim 1, wherein the area S1 is within a range from 0.01 mm² to 1 mm².

6. The electrode according to claim 1, wherein the material having electrical conductivity is a carbonaceous material.

7. The electrode according to claim 1, wherein the average primary particle size r of the active material particles is within a range from 0.5 μm to 5 μm.

8. A secondary battery comprising: an electrolyte; and
the electrode according to claim 1.

9. A battery pack comprising: the secondary battery according to claim 8.

10. The battery pack according to claim 9, further comprising: an external power distribution terminal; and
a protective circuit.

11. The battery pack according to claim 9, comprising a plurality of the secondary battery,
wherein the secondary batteries are electrically connected to in series, in parallel, or in a combination of in-series and in-parallel.

12. A vehicle comprising: the battery pack according to claim 9.

13. The vehicle according to claim 12, further comprising a mechanism configured to convert kinetic energy of the vehicle into regenerative energy.
